(19) United States
(12) Patent Application Publication
(10) Pub. No.: US 2019/0296351 A1
(43) Pub. Date: Sep. 26, 2019

(54) ELECTRODE, SECONDARY BATTERY, BATTERY PACK, AND VEHICLE

(71) Applicant: KABUSHIKI KAISHA TOSHIBA, Minato-ku (JP)

(72) Inventors: Kazuomi YOSHIMA, Yokohama (JP); Yasuhiro Harada, Isehara (JP); Norio Takami, Yokohama (JP)

(73) Assignee: KABUSHIKI KAISHA TOSHIBA, Minato-ku (JP)

(21) Appl. No.: 16/122,091

(22) Filed: Sep. 5, 2018

(30) Foreign Application Priority Data
Mar. 26, 2018 (JP) 2018-057469

(51) Int. Cl. H01M 4/583; H01M 4/485; H01M 10/0525; H01M 10/42; H01M 2/10; H01M 2/30; H01M 4/66

(52) U.S. Cl. CPC H01M 4/583; H01M 4/485; H01M 10/0525; H01M 2004/021; H01M 2/1016; H01M 2/30; H01M 4/661; H01M 10/425

(57) ABSTRACT

According to one embodiment, an electrode is provided. The electrode includes a current collector and an active material-containing layer. The active material-containing layer includes an active material complex and a conductive agent. The active material complex includes particles of a niobium-titanium composite oxide and a carbon-containing layer. The carbon-containing layer covers at least one part of surfaces of the particles of the niobium-titanium composite oxide. A resistance value ρs·S satisfies the following formula (1). The resistance value ρs·S is calculated from a specific surface area S (m²/g) of the active material complex by a nitrogen BET method and a sheet resistance value ρs (Ω/m²) of the electrode.

1 Ω/g≤ρs·S≤50 Ω/g (1)

### CROSS-REFERENCE TO RELATED APPLICATIONS

This application is based upon and claims the benefit of priority from Japanese Patent Application No. 2018-057469, filed Mar. 26, 2018, the entire contents of which are incorporated herein by reference.

### FIELD

Embodiments described herein relate generally to an electrode, a secondary battery, a battery pack, and a vehicle.

### BACKGROUND

Recently, as a high-energy density battery, a nonaqueous electrolyte battery such as a lithium ion secondary battery has been subjected to extensive research and development. The nonaqueous electrolyte battery is expected as a power supply for a hybrid automobile or an electric automobile or as an uninterruptible power supply for a portable telephone base station. In particular, battery having excellent output performance and life performance is demanded as an onboard battery.

The nonaqueous electrolyte battery includes, for example, a positive electrode, a negative electrode, a separator located between the positive electrode and the negative electrode, and a nonaqueous electrolyte. Each of the positive electrode and the negative electrode includes a current collector and an active material-containing layer provided on the current collector. The active material-containing layer includes the active material. The active material is capable of allowing lithium ions and electrons to be inserted in and extracted from the active material. The nonaqueous electrolyte contains an electrolyte salt, and a nonaqueous solvent capable of dissolving the electrolyte salt. In such a nonaqueous electrolyte battery, lithium ions move between the positive electrode and the negative electrode via the separator and the nonaqueous electrolyte, thereby performing charge and discharge.

A conductive agent is sometimes compounded in the active material-containing layer to improve the output performance. The conductive agent enhances current collection performance and suppresses a contact resistance between the active material and the current collector. The conductive agent is, for example, a carbonaceous substance such as carbon black or graphite.

However, there is still room for improvement for the output performance and the life performance of the secondary battery.

### BRIEF DESCRIPTION OF THE DRAWINGS

FIG. 1 is a cross-sectional view schematically showing an example of a secondary battery according to the embodiment;

FIG. 2 is an enlarged cross-sectional view of section A of the secondary battery shown in FIG. 1;

FIG. 3 is a partially cut-out perspective view schematically showing another example of a secondary battery according to the embodiment;

FIG. 4 is an enlarged cross-sectional view of section B of the secondary battery shown in FIG. 3;

FIG. 5 is a perspective view schematically showing an example of the battery module according to the embodiment;

FIG. 6 is an exploded perspective view schematically showing an example of the battery pack according to the embodiment;

FIG. 7 is a block diagram showing an example of an electric circuit of the battery pack shown in FIG. 6;

FIG. 8 is a cross-sectional view schematically showing an example of a vehicle according to the embodiment;

FIG. 9 is a view schematically showing another example of the vehicle according to the embodiment;

FIG. 10 shows the Raman spectrum of the active material complex AC1 used in Example 1 and that of the active material complex AC4 used in Comparative Example 1;

FIG. 11 is a schematic view of the crystal structure of monoclinic Nb2TiO7;

FIG. 12 is a schematic view of the crystal structure shown in FIG. 11 as viewed from another direction;

FIG. 13 is a view showing an example of the SEM image (×20000 magnification) of the particles of niobium-titanium composite oxide;

FIG. 14 is a view showing another example of the SEM image (×20000 magnification) of the particles of niobium-titanium composite oxide;

FIG. 15 is a front view showing a state in which the measurement sample is viewed from just above; and

FIG. 16 is a graph showing an example of the relationship between the carbon amount and the specific surface area in the active material complex.

### DETAILED DESCRIPTION

According to one embodiment, an electrode is provided. The electrode includes a current collector and an active material-containing layer. The active material-containing layer is provided on at least one surface of the current collector. The active material-containing layer includes an active material complex and a conductive agent. The active material complex includes particles of a niobium-titanium composite oxide and a carbon-containing layer. The carbon-containing layer covers at least one part of surfaces of the particles of the niobium-titanium composite oxide. A resistance value ρs·S satisfies the following formula (1). The resistance value ρs·S is calculated from a specific surface area S (m²/g) of the active material complex by a nitrogen BET method and a sheet resistance value ρs (Ω/m²) of the electrode.

1Ω/g≤ρs·S≤50Ω/g (1)

According to another embodiment, a secondary battery is provided. The secondary battery includes a negative electrode, a positive electrode, and an electrolyte. At least one of the positive electrode and the negative electrode includes the electrode according to the embodiment.

According to another embodiment, a battery pack is provided. The battery pack includes the secondary battery according to the embodiment.

According to another embodiment, a vehicle is provided. The vehicle includes the battery pack according to the embodiment.

Embodiments will now be described with reference to the accompanying drawings. Note that the same reference numerals denote the same parts throughout the embodiments, and a repetitive description thereof will be omitted. The drawings are schematic views for explaining the embodiments and promoting understanding of the embodiments. Shapes, sizes, ratios, and the like are different from those in an actual device, and the design can appropriately be changed in consideration of the following explanation and known techniques.

As described above, the active material-containing layer of an electrode contains an active material and a conductive agent. As a method of improving the output performance of the secondary battery, an active material having a small particle size and a high specific surface area is used, or the compounding amount of the conductive agent in the active material-containing layer is increased. That is, when the active material having a small particle size and a high specific surface area is used, the diffusion property of lithium ions can be improved. In addition, when the compounding amount of the conductive agent is increased, the internal resistance of the electrode can be lowered.

However, when the active material having a small particle size and a high specific surface area is used, or the compounding amount of the conductive agent is increased, the energy density of the secondary battery may lower. That is, to form an active material-containing layer, a slurry containing an active material and a conductive agent is applied onto a current collector to form a coating, and the coating is then dried. Next, press working is performed for the dried coating, thereby obtaining an active material-containing layer having a high density. When the active material having a small particle size and a high specific surface area is used, or the compounding amount of the conductive agent is increased, the coatability of the slurry degrades, and a coating in which the components are evenly dispersed tends to be difficult to obtain. Since such a coating degrades moldability in press working as well, the active material-containing layer having the high density may be difficult to obtain, and the energy density tends to lower.

On the other hand, when an active material having a large particle size and a low specific surface area is used, or the compounding amount of the conductive agent is decreased, the diffusion property of lithium ions lowers, and the internal resistance becomes high. For this reason, the life of the secondary battery deteriorates.

Concerning this problem, the present inventors found that the output performance and the life performance can be made compatible by using, as an active material, an active material complex including a carbon-containing layer. The present invention is based on the findings.

### First Embodiment

According to the first embodiment, an electrode is provided. The electrode includes a current collector and an active material-containing layer. The active material-containing layer is provided on at least one surface of the current collector. The active material-containing layer contains an active material complex and a conductive agent. The active material complex contains particles of a niobium-titanium composite oxide and a carbon-containing layer. The carbon-containing layer covers at least a part of the surfaces of the particles of the niobium-titanium composite oxide. A resistance value ρs·S calculated from a specific surface area S (m²/g) of the active material complex by the nitrogen BET method and the sheet resistance value ρs (Ω/m²) of the electrode satisfies the following formula (1).

1Ω/g≤ρs·S≤50Ω/g (1)

In the electrode according to the first embodiment, the resistance value ρs·S ranges from 1 Ω/g to 50 Ω/g. The resistance value ρs·S is calculated by multiplying the specific surface area S of the active material complex and the sheet resistance value ρs of the electrode. The specific surface area S of the active electrode is obtained by the nitrogen BET method. The sheet resistance value ρs of the electrode is obtained by a method complying with JIS (Japanese Industrial Standards) H 0602 (1995). The resistance value ρs·S is considered to be almost equal to a resistance value per g of active material complex. That the resistance value ρs·S is small indicates that both the specific surface area S of the active material complex and the sheet resistance value ρs of the electrode are small. Hence, when an electrode whose resistance value ρs·S is 50 Ω/g or less is used, the output performance and the life performance can be made compatible.

On the other hand, that the resistance value ρs·S is excessively small can indicate that the specific surface area S of the active material complex is excessively low, or the compounding amount of the conductive agent is excessively large. Hence, when an electrode whose resistance value ρs·S is smaller than 1 Ω/g is used, the energy density of the secondary battery cannot be raised, and the output performance and the life performance cannot be made compatible.

The resistance value ρs·S preferably ranges from 1 Ω/g to 30 Ω/g, and more preferably ranges from 5 Ω/g to 20 Ω/g.

The specific surface area S of the active material complex preferably ranges from 0.1 m²/g to 5 m²/g. When an active material complex whose specific surface area S falls within this range is used, the output performance and the life performance of the secondary battery can be improved. The specific surface area S of the active material complex more preferably ranges from 1 m²/g to 4 m²/g.

The sheet resistance value ρs of the electrode preferably ranges from 1 Ω/m² to 25 Ω/m². The sheet resistance value ρs of the electrode is obtained by a method complying with JIS H 0602 (1995). When an electrode whose sheet resistance value ρs falls within this range is used, the output performance and the life performance of the secondary battery can be improved. The sheet resistance value ρs of the electrode more preferably ranges from 5 Ω/m² to 20 Ω/m².

Details of the electrode according to the first embodiment will be described below.

The electrode according to the first embodiment may be a battery electrode. The electrode according to the first embodiment can use as a negative electrode, for example.

The electrode according to the first embodiment can include a current collector and an active material-containing layer. The electrode can function as a positive electrode or a negative electrode depending on the potential of the counterpart electrode.

1) Current Collector

The current collector is a material which is electrochemically stable at the insertion and extraction potentials of lithium (Li) of the active material. For example, if the electrode is used as the negative electrode, the current collector is preferably made of copper, nickel, stainless, aluminum, or an aluminum alloy containing one or more elements selected from Mg, Ti, Zn, Mn, Fe, Cu, and Si. The thickness of the current collector is preferably 5 μm to 20 μm. The current collector having such a thickness can achieve a balance between the strength and reduction in weight of the electrode.

The current collector can include a portion on one side where the electrode active material-containing layer is not carried on any surfaces. This portion acts as an electrode current collector tab.

2) Active Material-Containing Layer

The density (the current collector is not included) of the active material-containing layer preferably falls within the range of 2.4 g/cm³ to 3 g/cm³. The density of the active material-containing layer can also be called an electrode density. When the electrode density falls within this range, the active material particles and the conductive agent appropriately come into tight contact. This makes a satisfactory balance between electron conductive path formation and electrolyte permeability in the electrode, and improves rapid charge-and-discharge performance and the life performance.

The active material-containing layer can contain a binder.

The active material complex, the conductive agent, and the binder in the active material-containing layer are preferably compounded in ratios of 68 wt % to 96 wt %, 2 wt % to 30 wt %, and 2 wt % to 30 wt %, respectively.

2-1) Active Material Complex

The active material complex contains particles of a niobium-titanium composite oxide and a carbon-containing layer. The carbon-containing layer covers part or whole of the surfaces of the particles of the niobium-titanium composite oxide.

In the active material complex, the carbon-containing layer preferably satisfies the following formula (2).

1.2<I_{G}/I_{D}≤5 (2)

In the formula (2), ID is a peak intensity of the D band that appears in a range of 1,280 to 1,400 cm⁻¹ in a Raman spectrum by Raman spectroscopy using a light source of 532 nm. I_{G} is a peak intensity of the G band that appears in a range of 1,530 to 1,650 cm⁻¹ in the above Raman spectrum.

The G band is a peak derived from a graphite structure and exhibits a high electric conductivity. On the other hand, the D band is a peak derived from the defect structure or metastable state of carbon and exhibits a high intensity with an sp3 hybrid orbit. When the peak intensity ratio I_{G}/I_{D} is 1.2 or less, the carbon-containing layer includes many defects of carbon. As a result, since the side reaction between the carbon-containing layer and the electrolyte is promoted, the output performance or life performance is adversely affected. On the other hand, if the peak intensity ratio I_{G}/I_{D} becomes larger than 5, the metastable states in the carbon-containing layer extremely decrease. The carbon-containing layer cannot maintain a sufficient strength, and the ununiformity of the distribution of the carbon-containing layer on the particle surfaces of the niobium-titanium composite oxide becomes large. The preferable range of the peak intensity ratio I_{G}/I_{D} is 1.5≤I_{G}/I_{D}≤4.

According to the active material complex, the particle surfaces of the niobium-titanium composite oxide can be evenly covered with the high crystalline carbon-containing layer. Hence, when the active material complex is used for an electrode, the niobium-titanium composite oxide is packed in the electrode at a high density. In addition, since the crystallinity of the carbon-containing layer is high, an electrode having a high active material packing density and excellent conductivity can be implemented. As a result, it is possible to provide a secondary battery and a battery pack with a high energy density and excellent input/output performance. In addition, since the adhesion between the carbon-containing layer and the particle surfaces of the niobium-titanium composite oxide is high, peeling of the carbon-containing layer caused by expansion/contraction of the niobium-titanium composite oxide particles in a charge-and-discharge reaction can be suppressed. It is therefore possible to raise the durability of the active material complex and improve the life of the electrode and the secondary battery.

The thickness of the carbon-containing layer can be 0.1 nm to 10 nm.

The covering amount of the carbon-containing layer preferably ranges from 0.1 parts by weight to 3 parts by weight with respect to 100 parts by weight of the niobium-titanium composite oxide. If the covering amount of the carbon-containing layer is small, the conductive path between niobium-titanium composite oxide particles can hardly be improved. On the other hand, if the covering amount is large, compaction moldability in the press process at the time of electrode production becomes poor because of the bulkiness of the carbon-containing layer, and the electrode density hardly rises. For this reason, a high energy density cannot be achieved.

Here, in the active material complex, the particle surfaces of the niobium-titanium composite oxide are evenly covered with the high crystalline carbon-containing layer. Hence, even if the covering amount of the carbon-containing layer increases, the specific surface area hardly becomes high. That is, in an active material complex containing a low crystalline uneven carbon-containing layer, when the covering amount of the carbon-containing layer increases, an agglomeration of carbon can be generated. Since the agglomeration of carbon has a low bulk density, the specific surface area of the active material complex containing such an agglomeration of carbon tends to be high. However, in the active material complex in which the particle surfaces are evenly covered with the high crystalline carbon-containing layer, an agglomeration of carbon is not generated even if the covering amount of the carbon-containing layer increases. Hence, the specific surface area is hard to become high, and a predetermined specific surface area can be maintained.

FIG. 16 is a graph showing an example of the relationship between the carbon amount and the specific surface area in the active material complex. Referring to FIG. 16, the abscissa represents the carbon amount of the active material complex, and the ordinate represents the specific surface area of the active material complex. The carbon amount of the active material complex is the ratio of the carbon-containing layer in the active material complex. In FIG. 16, a graph “uneven” is directed to an active material complex which is the particles of the niobium-titanium composite oxide unevenly covered with a low crystalline carbon-containing layer having the peak intensity ratio I_{G}/I_{D} is 1.2 or less. In addition, a graph “even” is directed to an active material complex which is the particles of the niobium-titanium composite oxide evenly covered with a high crystalline carbon-containing layer having the peak intensity ratio I_{G}/I_{D} is higher than 1.2 and 5 or less.

As shown in FIG. 16, even if the carbon amount increases, the specific surface area of the active material complex evenly covered with the high crystalline carbon-containing layer is almost the same as that of the active material that is not covered with the carbon-containing layer. To the contrary, the specific surface area of the active material complex unevenly covered with the low crystalline carbon-containing layer becomes high along with the increase in the carbon amount.

The carbon-containing layer is permitted to contain an inevitable impurity such as hydrogen atoms or oxygen atoms. In addition, the carbon-containing layer can have a laminar structure, a granular structure, or a mixed form of laminar and granular structures.

The particles of the niobium-titanium composite oxide can be primary particles, secondary particles, or a mixed form of primary and secondary particles. A secondary particle is an aggregate of primary particles formed by agglomerated primary particles. In addition, the primary particle is a single primary particle that does not take the form of a secondary particle.

The content of the particles of the niobium-titanium composite oxide in the active material complex preferably falls within the range of 75 wt % to 100 wt %.

The representative composition of the niobium-titanium composite oxide is, for example, Nb₂TiO₇. At least a part of the niobium-titanium composite oxide preferably has, though is not limited to, a crystal structure having symmetry of a space group C2/m and an atomic coordination described in Journal of Solid State Chemistry 53, pp. 144-147 (1984).

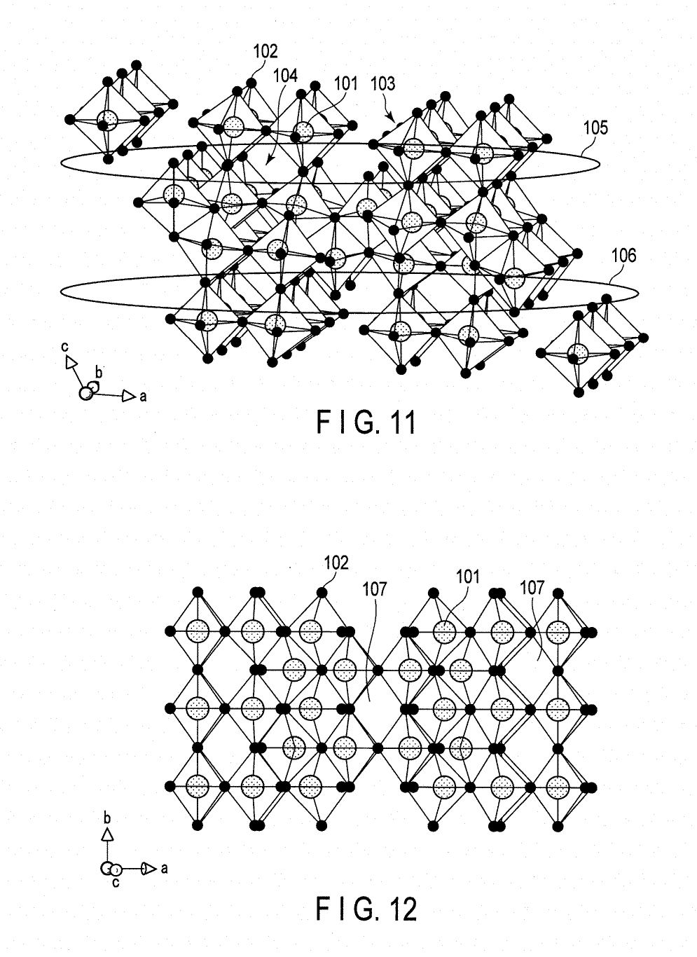

The niobium-titanium composite oxide mainly exhibits a monoclinic crystal structure. As an example, FIGS. 11 and 12 are schematic views of the crystal structure of monoclinic Nb₂TiO₇.

As shown in FIG. 11, in the crystal structure of the monoclinic Nb₂TiO₇, metal ions 101 and oxide ions 102 form a skeleton structure portion 103. At the positions of the metal ions 101, Nb ions and Ti ions are arranged at random at a ratio of Nb:Ti=2:1. When the skeleton structure portions 103 are alternately three-dimensionally arranged, vacancies 104 exist between the skeleton structure portions 103. The vacancies 104 serve as the host of lithium ions. The lithium ions can be inserted into the crystal structure from 0 mol up to 5.0 mol at maximum. A composition obtained when 5.0 mol of lithium ions are inserted can be expressed as Li₅Nb₂TiO₇.

In FIG. 11, a region 105 and a region 106 are portion having two-dimensional channels in the [100] direction and the [010] direction. As shown in FIG. 12, in the crystal structure of the monoclinic Nb₂TiO₇, vacancies 107 exist in the [001] direction. The vacancy 107 has a tunnel structure advantageous in conducting the lithium ions and forms a conductive path in the [001] direction that connects the region 105 and the region 106. The existence of the conductive path allows the lithium ions to move between the region 105 and the region 106.

Furthermore, in the above-described crystal structure, when the lithium ions are inserted into the vacancies 104, the metal ions 101 that form the skeleton are reduced to trivalent, and the electrical neutrality of the crystal is thus maintained. In the niobium-titanium composite oxide, not only reduction of Ti ions from quadrivalent to trivalent but also reduction of Nb ions from pentavalent to trivalent is performed. For this reason, the reduction valence per active material weight is large. It is therefore possible to maintain the electrical neutrality of the crystal even if many lithium ions are inserted. For this reason, the energy density is high as compared to a compound such as titanium oxide containing only quadrivalent cations. In addition, the niobium-titanium composite oxide has a lithium insertion potential of about 1.5 V (vs. Li/Li⁺). Hence, an electrode containing the niobium-titanium composite oxide as an active material can implement a battery capable of performing stable repetitive rapid charge-and-discharge.

The niobium-titanium composite oxide contains at least one material selected from the group consisting of, for example, Nb₂TiO₇, Nb₂Ti₂O₉, Nb₁₀Ti₂O₂₉, Nb₁₄TiO₃₇, and Nb₂₄TiO₆₂. The niobium-titanium composite oxide may be a substituted niobium-titanium composite oxide in which at least a part of Nb and/or Ti is substituted with a different kind of element. Examples of the substituting element are Na, K, Ca, Co, Ni, Si, P, V, Cr, Mo, Ta, Zr, Mn, Fe, Mg, B, Pb, and Al. The substituted niobium-titanium composite oxide may contain one kind of substituting element or may contain one two or more kinds of substituting elements. The active material particles may contain one kind of niobium-titanium composite oxide or may contain a plurality of kinds of niobium-titanium composite oxides. The niobium-titanium composite oxide preferably contains the monoclinic niobium-titanium composite oxide Nb₂TiO₇. This makes it possible to obtain an active material complex capable of achieving an electrode and a secondary battery having an excellent energy density and input/output performance.

The monoclinic niobium-titanium composite oxide may contain Li. Li can be contained in the monoclinic niobium-titanium composite oxide by synthesis but may be contained in the monoclinic niobium-titanium composite oxide by a charge-and-discharge reaction. The Li amount in the monoclinic niobium-titanium composite oxide containing Li can vary because of the influence of the charge-and-discharge reaction.

Examples of the monoclinic niobium-titanium composite oxide are a compound represented by LiₐTi₁₋ₓM1ₓNb_{2-y}M2_{y}O₇. Here, 0≤a≤5, 0≤x<1, 0≤y<1, M1 is at least one element selected from the group consisting of Nb, V, Ta, Fe, Bi, Sb, As, P, Cr, Mo, W, B, Na, Mg, Al, and Si, and M2 is at least one element selected from the group consisting of V, Ta, Fe, Ti, Bi, Sb, As, P, Cr, Mo, W, B, Na, Mg, Al, and Si. M1 and M2 may be the same or may be different from each other.

As another example of the monoclinic niobium-titanium composite oxide is a compound represented by LiₐTi₁₋ₓMₓNb₂O₇. Here, 0≤a≤5, 0≤x<1, M is at least one element selected from the group consisting of Nb, V, Ta, Bi, Sb, As, P, Cr, Mo, W, B, Na, Mg, Al, and Si. When the particles of a monoclinic niobium-titanium composite oxide having this composition are used, the input/output performance of the active material can be made higher.

The active material complex may contain another active material other than the niobium-titanium composite oxide. Examples of the other active material are a lithium titanate (for example, Li_{2+y}Ti₃O₇, 0≤y≤3) having a ramsdellite structure, a lithium titanate (for example, Li₄₊ₓTi₅O₁₂, 0≤x≤3) having a spinel structure, a monoclinic titanium dioxide (TiO₂(B)), an anatase type titanium dioxide, a rutile type titanium dioxide, a hollandite type titanium composite oxide, and an orthorhombic titanium containing composite oxide.

The BET specific surface area of the particles of the niobium-titanium composite oxide is not particularly limited and preferably ranges from 0.1 m²/g to 100 m²/g. If the specific surface area is 0.1 m²/g or more, the contact area to the electrolyte can be ensured. A satisfactory discharge rate characteristic can easily be obtained, and the charge time can be shortened. On the other hand, if the specific surface area is less than 100 m²/g, the reactivity to the electrolyte does not become too high, and the life characteristic can be improved. In addition, if the specific surface area is less than 100 m²/g, the coatability of a slurry containing the active material, which is to be used for the manufacture of an electrode to be described later, can be improved.

The particles of the niobium-titanium composite oxide preferably include a plurality of primary particles of the niobium-titanium composite oxide. Preferably, an average value (FUₐᵥₑ) of a roughness shape coefficient FU according to Formula (3) below is 0.70 or more in 100 primary particles among the plurality of primary particles. Each of the 100 primary particles has a particle size of 0.2 times to 4 times an average particle size (D50) determined from a particle size distribution chart of the plurality of primary particles obtained by a laser diffraction scattering method.

$$FU = \frac{f}{{f}_{c}} = \frac{4 π a}{{𝓁}^{ 2}} \qquad ( 3 )$$

In formula (3), 1 represents an outer circumference length of a projected cross-section of each of the 100 primary particles, and a represents a cross-sectional area in the projected cross-section of each of the 100 primary particles. π is the circular constant and is regarded as 3.14.

More specifically, the average particle size (D50) of the primary particles is calculated from the particle size distribution chart for the particles of the niobium-titanium composite oxide, and 100 primary particles are extracted from a plurality of primary particles each having a particle size of 0.2 times to four times of the value D50. Next, for each of the particles, the value of the uneven shape coefficient FU is calculated in accordance with formula (3). Note that a detailed method of extracting 100 primary particles will be described later.

Since the primary particles of the niobium-titanium composite oxide, which satisfy formula (3), are not obtained by a strong pulverization process, the crystallinity of the primary particles is high. In addition, the niobium-titanium composite oxide particles include many primary particles with smooth surfaces. For this reason, the surfaces of the niobium-titanium composite oxide particles can be thinly and evenly covered with the carbon-containing layer satisfying formula (2). As a result, since compaction moldability of the active material complex can greatly be improved, the adhesion between the niobium-titanium composite oxide particles becomes high, and the conductive path between the niobium-titanium composite oxide particles can be improved. The average value FUₐᵥₑ of the uneven shape coefficients FU preferably falls within the range of 0.7 to 1, and more preferably falls within the range of 0.7 to 0.85.

The average particle size (D50) of the niobium-titanium composite oxide particles preferably falls within the range of 0.5 μm to 5 μm, and more preferably falls within the range of 0.5 μm to 2 μm. If the average particle size (D50) of the primary particles is less than 0.5 μm, the specific surface area becomes high, and many voids exist in the electrode. It is therefore difficult to raise the electrode density. As a result, the contact property between the active material particles in the electrode and the contact property between the active material particles and the conductive agent deteriorate, and the life performance tends to lower. In addition, since the reactivity to the electrolyte becomes high because of the high specific surface area, and film formation on the electrode surface raises the resistance, the rapid charge-and-discharge performance tends to lower. On the other hand, if the average particle size (D50) of the primary particles is larger than 50 μm, the Li ion diffusion distance in a solid body becomes long, and the rapid charge-and-discharge performance tends to lower. A method of deciding the average particle size (D50) of the plurality of primary particles contained as the active material will be described later.

<Manufacturing Method>

A method of synthesizing the particles of the niobium-titanium composite oxide is not particularly limited, and, for example, a solid phase method, a hydrothermal method, a sol-gel method, a coprecipitation method, or the like can be employed.

Niobium-titanium composite oxide particles that satisfy formula (3) can be manufactured by, for example, the following method.

First, starting materials are mixed. As the starting materials for the niobium-titanium composite oxide, oxides or salts containing Ti and Nb are used. The salt used as the starting material is preferably a salt such as carbonate or nitrate, which decomposes at a relatively low temperature and generates an oxide. In addition, the particle size of these starting materials preferably falls within the range of 0.1 μm to 10 μm, and more preferably falls within the range of 0.1 μm to 5 μm. This is because if the particle size is smaller than 0.1 μm, the particles readily rise in the atmosphere at the time of mixing to cause compositional deviation, and if the particle size is larger than 10 μm, an unreacted product is generated.

When mixing the starting materials, an Nb source and a Ti source are mixed at such a molar ratio that does not generate a target composition. For example, if the ratio of Nb and Ti in the target composition is not 1:1, they are mixed at a molar ratio of 1:1 such that the Nb source and the Ti source as the raw materials have moles in equal number. The mixed raw materials undergo temporary firing at a temperature within the range of 500° C. to 1,000° C. for about 2 to 5 hrs. Next, an additional starting materials are mixed in amounts that generate the target composition with the powder after temporary firing. With this addition, the element ratio of the whole starting materials used matches the target composition. The mixture after the addition of the raw materials further undergoes final firing. The final firing is performed divisionally in two or more firing processes at a temperature of 1,000° C. to 1,450° C. for a total of 10 to 40 hrs. After the final firing, an annealing process is preferably further performed at a temperature lower than the temperature of the final firing. The annealing process is executed by performing a heat treatment at a temperature of 350° C. to 800° C. for 1 to 5 hrs. Oxygen defects in the niobium-titanium composite oxide can be repaired by performing the annealing process. Therefore, a high capacity and excellent life performance can be achieved.

The powder after the firing is quickly removed from the electric furnace and cooled to the room temperature. This cooling is preferably done under a condition that the temperature of the fired product lowers from the temperature at the time of firing to 100° C. or less within 1 hr.

In this way, instead of mixing the starting materials at the target composition and firing them from beginning, the composition ratio of the raw materials mixed at the time of temporary firing is made different from the composition ratio of the raw materials mixed at the time of final firing, and the firing is performed divisionally in two or more steps, thereby suppressing the growth of the primary particles. The reason for this is as follows. If firing is performed at the mixing ratio of the target composition from beginning, the firing reaction progresses at once from particle necking to particle growth. However, under a mixing ratio different from the target composition, excess or deficiency of the raw materials occurs. Hence, the raw material particles remain between reacting particles, and the particle growth can be suppressed.

The surfaces of the plurality of active material particles in which the growth of the primary particles is suppressed are smooth. That is, according to this manufacturing method, it is possible to manufacture the particles of the niobium-titanium composite oxide satisfying formula (3).

Note that lithium ions may be inserted into the niobium-titanium composite oxide synthesized by the above-described method by charging the battery. Alternatively, the niobium-titanium composite oxide may be synthesized as a composite oxide containing lithium by using a compound containing lithium such as lithium carbonate as a starting material, as described above.

The particles of the niobium-titanium composite oxide and a solution in which a carbon source is dispersed are mixed using, for example, a ball mill and then dried, thereby obtaining a complex including the niobium-titanium composite oxide particles and a phase including a carbon containing compound that covers at least a part of the surfaces of the particles. Reduction firing is executed for the obtained complex under an inert atmosphere such as a nitrogen atmosphere, thereby forming a carbon-containing layer on the surface of each particle of the niobium-titanium composite oxide.

Examples of the carbon source include a water-soluble saccharide, a water-soluble alcohol, a water-soluble polymer, and an acrylic resin. Examples of the water-soluble saccharide are sucrose, glucose, maltose, and sodium alginate. An example of the water-soluble alcohol is polyvinyl alcohol (PVA). An example of the water-soluble polymer is carboxymethyl cellulose (CMC). Examples of the acrylic resin are acrylate, methacrylate, and polymethyl methacrylate. The acrylic resin has a high absorption property to the particle surfaces of the niobium-titanium composite oxide. For this reason, the acrylic resin is useful for synthesis of the active material complex.

The additive amount of the carbon source is preferably set to 1 part by weight to 20 parts by weight with respect to 100 parts by weight of the particles of the niobium-titanium composite oxide

Examples of a solvent in which the carbon source is dispersed include water and alcohol. Examples of the alcohol are ethanol and ethylene glycol. The solvent is preferably a solvent mixture containing water and alcohol. When the solvent mixture is used, and the drying temperature is set to 50° C. to 90° C., it is possible to decrease the amount of the solvent remaining on the particle surfaces while gradually evaporating the solvent. Hence, the carbon source can be thinly and evenly applied to the particle surfaces.

A viscosity μ of the solution in which the carbon source is dispersed is preferably set within the range of 0.1 Pa·s to 100 Pa·s. If the viscosity is small, the solution can hardly be evenly applied to the particle surfaces because the fluidity of the solution is high. On the other hand, if the viscosity is large, the carbon-containing layer becomes thick. The preferable range is the range of 5 Pa·s to 80 Pa·s.

The particles of the niobium-titanium composite oxide, the carbon source, and the solvent may be mixed by putting them not in a ball mill but in an autoclave and performing a hydrothermal treatment at 80° C. to 200° C. for 0.5 to 10 hrs.

The drying temperature is preferably set to 50° C. to 90° C. When the drying temperature is set within this range, the solvent can slowly be evaporated. It is therefore possible to thinly and evenly apply the carbon source to the particle surfaces.

As for the condition of reduction firing, reduction firing is performed at a temperature of 500° C. to 1,000° C., preferably, 600° C. to 900° C. at 0.1 to 40 hrs. If the firing temperature is low, or the firing time is short, the crystallinity of the carbon-containing layer lowers. On the other hand, if the firing temperature is high, or the firing time is long, oxygen defects readily occur in the niobium-titanium composite oxide, and the performance of the niobium-titanium composite oxide deteriorates.

The carbon-containing layer that satisfies formula (2) is obtained by, for example, thinly and evenly applying the carbon source to the particle surfaces of the niobium-titanium composite oxide and then performing reduction firing under the above-described condition. When the conditions such as the combination of the carbon source and the solvent, the viscosity of the solution in which the carbon source is dispersed, and the drying temperature of the solution are adjusted, the carbon source can be thinly and evenly applied to the particle surfaces of the niobium-titanium composite oxide.

<Measurement by Raman Spectroscopy>

A microscopic Raman spectroscopic measurement device is used. As the measurement device, for example, Nicolet Almega® available from Thermo Fisher Scientific or a device with a function equivalent to this can be used. As the measurement conditions, the wavelength is 532 nm, the slit size is 25 μm, the laser intensity is 10%, the exposure time is 10 s, and the integration count is 10. Fitting by a Lorentz function is executed for the obtained Raman spectrum, thereby calculating a ratio I_{G}/I_{D} of peak intensities (I_{D}, I_{G}) between a D band having a peak top almost at 1,350 cm⁻¹ and a G band having a peak top almost at 1,580 cm⁻¹.

<State and Thickness of Carbon-Containing Layer>

The state and thickness of the carbon-containing layer can be confirmed by TEM (Transmission Electron Microscopy) observation. More specifically, first, ruthenium is absorbed to the surface of the active material complex by a vapor deposition method. Next, the active material complex is buried in a resin, and a thin film is formed by ion milling using DualMill 600 available from GATAN or a device with a function equivalent to this. Then, TEM observation is performed for arbitrary primary particles of the active material complex. The dispersibility of the carbon-containing layer on the particles can be grasped by this observation. This observation is performed for 10 or more particles, and the average value of the thicknesses of the carbon-containing layers is calculated as the thickness of the carbon-containing layer. As the TEM apparatus, for example, H-9000UHR III available from Hitachi or a device with a function equivalent to this is used. In this measurement, the acceleration voltage is set to 300 kV, and the image magnification is set to 2,000,000×.

<Determination of Average Value FUₐᵥₑ of Roughness Shape Coefficient FU>

A method of determining the average value FUₐᵥₑ of the roughness shape coefficient FU for a plurality of primary particles including a niobium-titanium composite oxide will be described.

When the active material particles contained in the battery are to be measured, the active material is taken out from the battery by the following procedure.

First, the battery is completely discharged. The battery is discharged at a 0.1 C current up to a rated final voltage in an environment of 25° C. so that the battery can be put into the state-of-discharge.

Next, the battery is disassembled in a glove box filled with argon and the electrode body (or the electrode group) is taken out. The electrode body is washed with an appropriate solvent and dried under reduced pressure at 60° C. for 12 hours. As the washing solvent, for example, ethyl methyl carbonate or the like can be used. Thus, the organic electrolyte contained in the electrode body can be removed. Then, the electrode is cut into two electrode pieces. One of the cut electrode pieces is immersed in a solvent (preferably an organic solvent such as alcohol or NMP), and ultrasonic waves are applied. Thereby, the current collector and the electrode constituent material contained in the electrode body can be separated. Next, a dispersion solvent in which the electrode constituent material is dispersed is placed in a centrifuge, and only the active material particles are separated from the powder in the electrode body containing a conductive agent such as carbon.

Subsequently, a method of measuring the particle size distribution of the active material particles prepared as described above will be described.

The active material powder is subjected to particle size distribution measurement by the laser diffraction scattering method so that the average particle size (D50) of the primary particles can be determined from the cumulative frequency curve of the active material particles. As a laser diffractometer, for example, MT 3000 II (manufactured by MicrotracBell Corp.) can be used.

However, when the active material particles to be measured mainly contain secondary particles, it is difficult to measure the average particle size (D50) of the primary particles using the laser diffractometer. Therefore, in this case, it is necessary to estimate the average particle size (D50) of the primary particles by observing a scanning electron microscope (SEM) image. Whether the active material particles to be measured mainly include secondary particles or not is judged by observation with SEM. The active material powder is affixed to a stage for SEM with a carbon tape and the observation is performed at a magnification that the boundary line of the outer circumference (contour) of the primary particle is clearly visible, for example, at 5000 to 20000 magnifications. Regarding 100 arbitrary particles in this SEM image, the respective particle sizes are determined by the following procedure. Among circles (i.e., circumscribed circles) enveloping the target particles, a circle having the smallest diameter (referred to as “minimum circumscribed circle”) is drawn, and the diameter of this circle is defined as the particle size. An average value of particle sizes determined for the arbitrary 100 particles is used as a substitute value for the average particle size (D50) of primary particles.

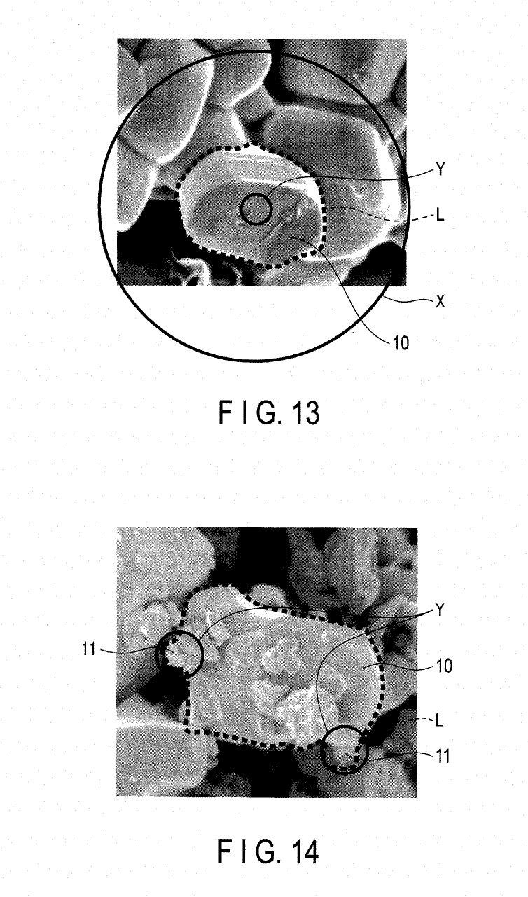

Next, the roughness shape coefficient FU is determined for each of the primary particles. This procedure will be described with reference to FIGS. 13 and 14. FIG. 13 is a view showing an example of the SEM image (×20000 magnification) of the particles of niobium-titanium composite oxide. FIG. 14 is a view showing another example of the SEM image (×20000 magnification) of the particles of niobium-titanium composite oxide. Regarding the specific definition of the roughness shape coefficient FU, the content of Non-Patent Document “Yuji Yoshimura and Shoji Ogawa (1993), SIMPLE QUANTIFICATION METHOD FOR GRAIN SHAPE OF GRANULAR MATERIALS SUCH AS SAND, Journal of the Japan Society of Civil Engineers, No. 463/III-22, pp. 95-103” is cited by reference.

The other one of the electrode pieces prepared previously is affixed to a stage for SEM with a carbon tape. At this time, the electrode piece is affixed so that the active material-containing layer can be observed from the perpendicular direction of the active material-containing layer. A total of 100 points in the central part in the short-side direction of the electrode is observed at equal intervals from the end of the electrode in the longitudinal direction. At each observation point, one primary particle that satisfies the following conditions is selected from the particles in which the boundary line of the outer circumference (contour) of the primary particle can be visually recognized clearly. Thus, a total of 100 primary particles is used as particles to be measured. The observation magnification is the magnification of the particle in which the boundary line of the outer circumference (contour) of the primary particle can be visually recognized clearly and is, for example, in the range of 5000 to 20000 magnifications.

First, the center of gravity is determined from the projected area of the primary particle. Here, a circle having a radius of the value of the D50 determined previously is defined as a circle X. A circle having a radius of a value obtained by multiplying the value of the D50 by 0.1 times is defined as a circle Y. As shown in FIG. 13, when the centers of the circle X and the circle Y are superimposed on the center of gravity of a primary particle 10 to be measured, a primary particle in which an outer circumference L of the primary particle 10 is larger than the circle Y and smaller than the circle X is determined at each observation point.

Regarding the image of these 100 primary particles, a length l of the outer circumference L of the target particle 10 and a cross-sectional area a of the target particle 10 are determined using an image analysis tool. For example, ImageJ shown in Non-Patent Document “Dr. Michael et al., Image Processing with ImageJ, Reprinted from the July 2004 issue of Biophotonics International copyrighted by Laurin Publishing Co. INC.” can be used as the image analysis tool. From the obtained outer circumference length l and the cross-sectional area a, the roughness shape coefficient FU is calculated for each of the 100 primary particles selected according to the following Formula (3). Further, the average value FUₐᵥₑ of the calculated roughness shape coefficient FU of the 100 particles is calculated.

$$\begin{matrix}[ Formula 3 ] & \\ FU = \frac{f}{{f}_{c}} = \frac{4 π a}{{𝓁}^{ 2}} & ( 3 )\end{matrix}$$

In measuring the outer circumference length l of the target particle 10 and the cross-sectional area a of the target particle 10, when fine particles 11 having a particle size smaller than the circle Y are attached to the surface and/or outer circumference of the primary particle 10 to be measured, the outer circumference including the fine particles 11 is defined as the outer circumference L of the primary particle 10 and measured. Further, the cross-sectional area a of the fine particle 11 is also measured, in addition to the cross-sectional area a of the target particle 10. The SEM image shown in FIG. 14 shows an example when the fine particles 11 having a smaller particle size than the circle Y are attached to the surface and/or outer circumference of the primary particle 10 to be measured. FIG. 14 shows that the particle size of the fine particles 11 is smaller than the circle Y. The reason for considering the outer circumference length and the cross-sectional area of the fine particle 11, in addition to the outer circumference length and the cross-sectional area of the primary particle 10 to be measured, is as follows. It is necessary to reflect the fact that the smoothness of the particle surface is lost because the fine particles 11 are attached to the surface of the primary particle 10 on the value of the roughness shape coefficient FU.

<Confirmation of Crystal Structure of Active Material>

The crystal structure of the active material can be confirmed by combining powder XRD (X-Ray Diffraction) and analysis by the Rietveld method.

The powder XRD of the active material can be performed, for example, in the following way.

First, the active material is pulverized as needed to prepare a sample with an average particle size less than 5 μm. The average particle size can be obtained by a laser diffraction method. The obtained sample is packed in a holder portion that is 0.2 mm deep and is formed on a glass sample plate. Next, another glass plate is pressed from the outside to flatten the surface of the packed sample. Take care to pack an appropriate amount of sample so a crack, a void, unevenness, or the like is not formed in the packed sample. Also take care to press the glass plate by a sufficient pressure. Next, the glass plate in which the sample is packed is set in the powder XRD apparatus, and an XRD pattern is acquired using Cu-Kα rays.

Note that if the orientation of the sample is high, the peak position may be shifted, or the peak intensity ratio may change depending on the manner the sample is packed. Such a sample with a considerably high orientation is measured using a capillary. More specifically, the sample is inserted into the capillary, the capillary is placed on a rotary sample table, and measurement is performed. The influence of the orientation can be decreased by this measurement method. As the capillary, a capillary made of Lindemann glass is used.

The active material contained as the electrode material in the battery can be measured in the following way. First, a state in which lithium ions are completely extracted from the active material (for example, a niobium-titanium composite oxide) in the electrode material is set. For example, when this active material is used in a negative electrode, the battery is completely set in the discharged state. The crystal state of the active material can thus be observed. Remaining lithium ions may exist even in the discharged state. Due to the influence of the lithium ions remaining in the electrode, an impurity phase such as lithium carbonate or lithium fluoride may be mixed in the powder XRD result. The mixing of the impurity phase can be prevented by, for example, using an inert gas atmosphere as the measurement atmosphere or cleaning the electrode surface. Even if impurity phases exist, analysis can be performed while neglecting the phases.

Next, the battery is disassembled in a glove box filled with argon to extract an electrode. The extracted electrode is cleaned by an appropriate solvent. For example, ethyl methyl carbonate or the like can be used. The cleaned electrode is cut into almost the same area as the area of the holder of the powder XRD apparatus to obtain a measurement sample.

The cut sample (electrode) is directly bonded to a glass holder and measured. At this time, the position of a peak derived from an electrode substrate such as a metal foil is measured in advance. In addition, the peaks of other components such as a conductive agent and a binder are also measured in advance. If the peak of the substrate and the peak of the active material overlap, a layer (for example, an active material-containing layer to be described later) containing the active material is preferably peeled from the substrate and used in the measurement. This aims at separating the overlapping peaks when quantitatively measuring the peak intensity. For example, the active material layer can be peeled by irradiating the electrode substrate with an ultrasonic wave in a solvent. The active material layer is sealed in a capillary, the capillary is placed on a rotary sample table, and measurement is performed. With this method, it is possible to obtain the XRD pattern of the active material while reducing the influence of the orientation. The XRD pattern acquired at this time needs to be applicable to Rietveld analysis. To collect Rietveld data, the measurement time and/or the X-ray intensity is adjusted such that step width becomes ⅓ to ⅕ of the minimum half value width of the diffraction peak, and the intensity at the peak position of the strongest reflection becomes 5,000 to 10,000 counts.

The obtained XRD pattern is analyzed by the Rietveld method. In the Rietveld method, a diffraction pattern is calculated from a crystal structure model estimated in advance. By fitting the calculated values and actual measured values, parameters (a lattice constant, atomic coordinates, an occupation ratio, and the like) concerning the crystal structure can precisely be analyzed. The feature of the crystal structure of the synthesized oxide can thus be checked. In addition, the occupation ratio of a constituent element in each site can be checked.

As a scale to estimate the degree of matching between the observed intensity and the calculated intensity in the Rietveld analysis, a fitting parameter S is used. The analysis needs to be performed such that S becomes smaller than 1.8. In addition, when deciding the occupation ratio in each site, a standard deviation σⱼ needs to be taken into consideration. The fitting parameter S and the standard deviation σⱼ defined here are estimated by formulas described in Non-Patent Document “Izumi Nakai and Fujio Izumi, ACTUAL POWDER X-RAY ANALYSIS”, X-ray Analysis Research Meeting of Japan Society for Analytical Chemistry (Asakura Shoten), published on Jul. 10, 2009” (pages 97 to 115). Using this method, for a monoclinic niobium-titanium composite oxide having symmetry of a space group C2/m, a case in which fitting is performed assuming that cations evenly occupy in each metal cation occupied site of 2a or 4i in the crystal structure and a case in which fitting is performed, assuming that the cations are unevenly distributed, by setting an occupation ratio for each element are put to the test. As a result, a case in which the converged value of the fitting parameter S is smaller, that is, a case in which more excellent fitting is done can be determined to be close to the actual occupation state. It is therefore possible to determine whether the cations are arranged at random.

<Method of Confirming Composition of Active Material>

The composition of the active material can be analyzed using, for example, ICP (Inductively Coupled Plasma) atomic emission spectroscopy. At this time, the abundance ratio (molar ratio) of elements depends on the sensitivity of an analysis apparatus to use. Hence, the numerical value of a measured molar ratio may be deviated from the actual molar ratio by the error amount of the measurement apparatus. However, even if the numerical value is deviated within the error range of the analysis apparatus, the performance of the electrode according to this embodiment can sufficiently be exhibited.

To measure the composition of the active material incorporated in the battery by ICP atomic emission spectroscopy, specifically, the measurement is performed according to the following procedure.

First, by the procedure explained in the section of powder XRD, the electrode containing the active material as the measurement target is extracted from the secondary battery and cleaned. A portion such as the active material-containing layer containing the electrode active material is peeled from the cleaned electrode. The portion containing the electrode active material can be peeled by, for example, irradiating the portion with an ultrasonic wave. As a detailed example, the electrode is put in ethyl methyl carbonate in a glass beaker and vibrated in an ultrasonic cleaning machine, thereby peeling the active material-containing layer containing the electrode active material.

Next, the peeled portion is heated in the atmosphere for a short time (for example, at 500° C. for about 1 hr), thereby burning off unnecessary portions such as the binder component and carbon. When the residue is dissolved in an acid, a liquid sample containing the active material can be created. At this time, as the acid, hydrochloric acid, nitric acid, sulfuric acid, hydrogen fluoride, or the like can be used. When the liquid sample is subjected to ICP analysis, the composition in the active material can be known.

<Method of Measuring Specific Surface Areas of Active Material Particles and Active Material Complex>

The measurement of the specific surface areas of the active material particles and the active material complex can be performed by a method of absorbing molecules with a known absorption occupancy area to the powder particle surfaces at the temperature of liquid nitrogen and obtaining the specific surface area of the sample from the amount. The most commonly used is the BET method by low-temperature/low-humidity physical adsorption of an inert gas. This is the most famous theory as a method of calculating the specific surface area, which extends the Langmuir theory that is a monomolecular layer adsorption theory to multi-molecular adsorption. A specific surface area obtained by this method is called a BET specific surface area. As the inert gas, for example, nitrogen is used.

2-2) Conductive Agent

The conductive agent may be blended to improve current collection performance and to suppress the contact resistance between the negative electrode active material and the current collector. Examples of the conductive agent include vapor grown carbon fiber (VGCF), carbon black such as acetylene black, and carbonaceous materials such as graphite. One of these may be used as the conductive agent, or two or more thereof may be used in combination as the conductive agent.

As the conductive agent, two or more kinds of materials are preferably used in combination. As the conductive agent, for example, carbon black and graphite are used in combination. At this time, the average particle size of carbon back and that of graphite are preferably different from each other. More preferably, the average particle size of carbon back is smaller than the average particle size of graphite. The average particle size of carbon black preferably ranges from 0.1 μm to 2 μm. The average particle size of graphite preferably ranges from 4 μm to 6 μm.

2-3) Binder

The binder may be blended to fill the gaps of the dispersed active material with the binder and also to bind the active material and the electrode current collector. Examples of the binder include polytetrafluoro ethylene (PTFE), polyvinylidene fluoride (PVdF), fluorine-containing rubber, styrene-butadiene rubber, a polyacrylic acid compound, an imide compound, carboxymethyl cellulose (CMC) and salts of the CMC. One of these may be used as the binder, or two or more thereof may be used in combination as the binder.

3) Manufacturing Method

The electrode is produced by, for example, the following method. First, a slurry is prepared by suspending the active material complex, the conductive agent, and the binder in a solvent. The slurry is applied to one surface or both surfaces of the current collector. Next, the applied slurry is dried to obtain the laminated body of the active material-containing layer and the current collector. After that, pressing is performed for the laminated body. The electrode is thus produced.

Alternatively, the electrode may also be produced by the following method. First, an active material complex, a conductive agent, and a binder are mixed to obtain a mixture. Next, the mixture is formed into pellets. Then the electrode can be obtained by arranging the pellets on the current collector.

<Method of Measuring Sheet Resistance Value>

The sheet resistance value ρs of the electrode is obtained by a 4-terminal measurement method complying with JIS H 0602 (1995). As a measurement sample, a sample obtained by, for example, cutting the electrode extracted from the battery in the discharged state obtained by the above-described method into a square shape whose sides are 5 cm long each is used. An electrical resistance R is measured from two ends facing in the measurement sample, and this value can be obtained as the sheet resistance value ρs.

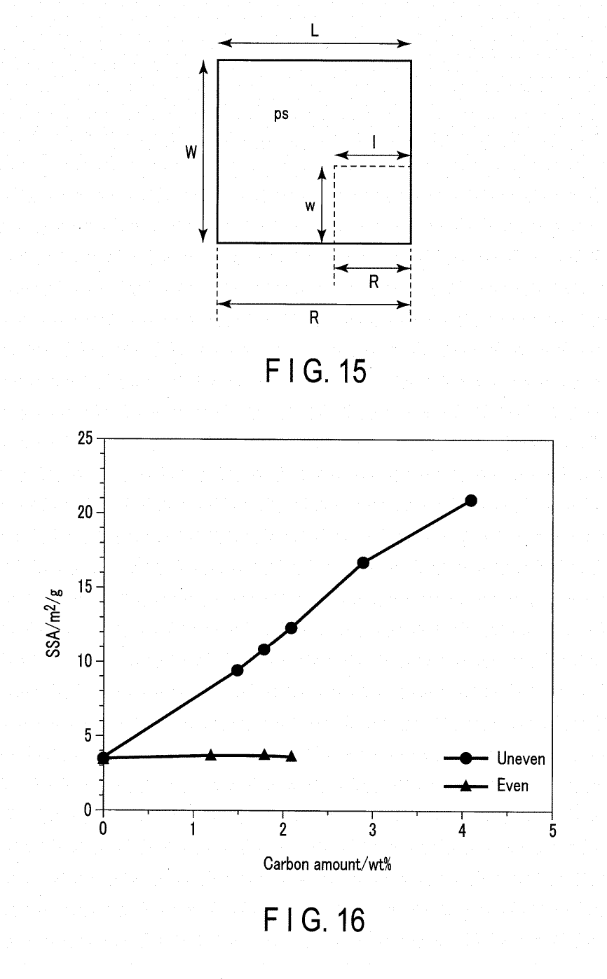

The measurement sample used in the 4-terminal measurement method will be described with reference to FIG. 15. FIG. 15 is a front view showing a state in which the measurement sample is viewed from just above. The measurement sample shown in FIG. 15 is obtained by cutting a sheet-shaped electrode into a square shape. In the measurement sample shown in FIG. 15, a length L of a horizontal side and a length W of a vertical side equal.

The sheet resistance value ρs can also be expressed as a value obtained by dividing a resistivity p by a thickness t of the measurement sample. Hence, even if the size of the measurement sample changes, the same value is calculated as the sheet resistance value ρs. That is, in FIG. 15, the sheet resistance value ρs calculated using, as the measurement sample, a measurement sample in which the lengths of a horizontal side and a vertical side are a length l and a length w, respectively, is the same value as the sheet resistance value ρs calculated using the measurement sample in which the lengths of a horizontal side and a vertical side are the length L and the length W, respectively. As shown in FIG. 15, the length l is shorter than the length L and the same as the length w. In addition, the length w is shorter than the length W.

In the electrode according to the above-described first embodiment, the resistance value ρs·S ranges from 1 Ω/g to 50 Ω/g. Hence, when this electrode is used, a secondary battery having excellent output performance and life performance can be implemented.

### Second Embodiment

According to a second embodiment, a secondary battery including a negative electrode, a positive electrode and an electrolyte is provided. At least one of the positive electrode and the negative electrode includes the electrode according to the first embodiment.

The secondary battery can further include a separator disposed between the positive electrode and the negative electrode. The positive electrode, the negative electrode, and the separator can constitute an electrode group. The electrolyte may be held in the electrode group. The secondary battery can further include a container member housing the electrode group and the electrolyte. Furthermore, the secondary battery can further include a positive electrode terminal electrically connected to the positive electrode and a negative electrode terminal electrically connected to the negative electrode.

The secondary battery may be a lithium secondary battery. The secondary battery includes nonaqueous electrolyte secondary battery containing a nonaqueous electrolyte.

Hereinafter, the negative electrode, the positive electrode, the electrolyte, the separator, the container member, the positive electrode terminal, and the negative electrode terminal will be described in detail.

(1) Negative Electrode

The negative electrode provided in the secondary battery according to the embodiment can be, for example, the electrode described in the first embodiment.

(2) Positive Electrode

The positive electrode provided in the secondary battery according to the embodiment can be, for example, the electrode described in the first embodiment. If the negative electrode is the electrode corresponding to the first embodiment, the positive electrode may be an electrode to be described below.

The positive electrode may include a positive electrode current collector and a positive electrode active material-containing layer. The positive electrode active material-containing layer may be formed on one surface or both of reverse surfaces of the positive electrode current collector. The positive electrode active material-containing layer may include a positive electrode active material, and optionally an electro-conductive agent and a binder.

As the positive electrode active material, for example, an oxide or a sulfide may be used. The positive electrode may include one kind of positive electrode active material, or alternatively, include two or more kinds of positive electrode active materials. Examples of the oxide and sulfide include compounds capable of having Li (lithium) and Li ions be inserted and extracted.

Examples of such compounds include manganese dioxides (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., Liₓ CoO₂; 0<x≤1), lithium nickel cobalt composite oxides (e.g., LiₓNi_{1-y} Co_{y}O₂; 0<x≤1, 0<y<1), lithium manganese cobalt composite oxides (e.g., LiₓMn_{y} Co_{1-y}O₂; 0<x≤1, 0<y<1), lithium manganese nickel composite oxides having a spinel structure (e.g., LiₓMn_{2-y}Ni_{y}O₄; 0≤x≤1, 0<y<2), lithium phosphates having an olivine structure (e.g., LiₓFePO₄; 0<x≤1, LiₓFe_{1-y}Mn_{y}PO₄; 0<x≤1, 0<y<1, and Liₓ CoPO₄; 0<x≤1), iron sulfates [Fe₂(SO₄)₃], vanadium oxides (e.g., V₂O₅), and lithium nickel cobalt manganese composite oxides (LiₓNi_{1-y-z} Co_{y}Mn_{z}O₂; 0<x≤1, 0<y<1, 0<z<1, y+z<1).

More preferred examples of the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., Liₓ CoO₂; 0<x≤1), lithium nickel cobalt composite oxides (e.g., LiNi_{1-y} Co_{y}O₂; 0<x≤1), lithium manganese nickel composite oxides having a spinel structure (e.g., LiₓMn_{2-y}Ni_{y}O₄; 0<x≤1, 0<y<2), lithium manganese cobalt composite oxides (e.g., LiₓMn_{y} Co_{1-y}O₂; 0<x≤1, 0<y<1), lithium iron phosphates (e.g., LiₓFePO₄; 0<x≤1), and lithium nickel cobalt manganese composite oxides(LiₓNi_{1-y-z} Co_{y}Mn_{z}O₂; 0<x≤1, 0<y<1, 0<z<1, y+z<1). The positive electrode potential can be made high by using these positive electrode active materials.

When an room temperature molten salt is used as the nonaqueous electrolyte of the battery, preferred examples of the positive electrode active material include lithium iron phosphate, LiₓVPO₄F (0≤x≤1), lithium manganese composite oxide, lithium nickel composite oxide, and lithium nickel cobalt composite oxide. Since these compounds have low reactivity with room temperature molten salts, cycle life can be improved. The room temperature molten salt will be described later in detail.

The positive electrode active material particles may have, for example, a form of primary particles or a form of secondary particles made by agglomerated primary particles. The positive electrode active material particles may be a mixture of primary particles and secondary particles.

The primary particle size of the positive electrode active material is preferably within a range of from 100 nm to 2 μm. The positive electrode active material having a primary particle size of 100 nm or more is easy to handle during industrial production. In the positive electrode active material having a primary particle size of 2 μm or less, diffusion of lithium ions within solid can proceed smoothly.

The BET specific surface area of the positive electrode active material is preferably within a range of from 0.1 m²/g to 10 m²/g. The positive electrode active material having a specific surface area of 0.1 m²/g or more can secure sufficient sites for inserting and extracting Li ions. The positive electrode active material having a specific surface area of 10 m²/g or less is easy to handle during industrial production, and can secure a good charge and discharge cycle performance.

The conductive agent is added to improve a current collection performance and to suppress the contact resistance between the active material and the current collector. Examples of the conductive agent include vapor grown carbon fiber (VGCF), carbon black such as acetylene black, and carbonaceous substances such as graphite. One of these may be used as the conductive agent, or two or more may be used in combination as the conductive agent. The conductive agent may be omitted.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluorine rubber, polyacrylate compounds, imide compounds, carboxymethyl cellulose (CMC), and salts of the CMC. One of these may be used as the binder, or two or more may be used in combination as the binder.

In the positive electrode active material-containing layer, the positive electrode active material and binder are preferably blended in proportions within ranges of 80% by mass to 98% by mass, and 2% by mass to 20% by mass, respectively. When a conductive agent is added, the positive electrode active material, binder, and conductive agent are preferably blended in proportions of 77% by mass to 95% by mass, 2% by mass to 20% by mass, and 3% by mass to 15% by mass, respectively.

The positive electrode current collector is preferably an aluminum foil, or an aluminum alloy foil containing one or more elements selected from the group consisting of Mg, Ti, Zn, Ni, Cr, Mn, Fe, Cu, and Si.

The thickness of the aluminum foil or aluminum alloy foil is preferably within a range of from 5 μm to 20 μm, and more preferably 15 μm or less. The purity of the aluminum foil is preferably 99% by mass or more. The amount of transition metal such as iron, copper, nickel, or chromium contained in the aluminum foil or aluminum alloy foil is preferably 1% by mass or less.

The positive electrode current collector can include a portion on one side where the positive electrode active material-containing layer is not carried on any surfaces. This portion acts as a positive electrode current collector tab.

(3) Electrolyte

As the electrolyte, for example, a liquid nonaqueous electrolyte or a gel nonaqueous electrolyte may be used. The liquid nonaqueous electrolyte is prepared by dissolving an electrolyte salt in an organic solvent. The concentration of the electrolyte salt is preferably 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethansulfonate (LiCF₃SO₃), bistrifluoromethylsulfonylimide lithium (LiTFSI; LiN(CF₃SO₂)₂), and mixtures thereof. The electrolyte salt is preferably less likely to be oxidized even at high potentials, and LiPF₆ is most preferred.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-MeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The gel-like nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, the nonaqueous electrolyte may be, for example, a room temperature molten salt (ionic melt) including lithium ions, a polymer solid electrolyte, or an inorganic solid electrolyte, other than the liquid nonaqueous electrolyte or the gel nonaqueous electrolyte.

The room temperature molten salt (ionic melt) means compounds which may exist in a liquid state at normal temperature (15 to 25° C.) among organic salts constituted of combinations of organic cations and anions. The room temperature molten salts include those which singly exist in a liquid state, those which are put into a liquid state when mixed with an electrolyte, those which are put into a liquid state when dissolved in an organic solvent, and mixture thereof. Generally, the melting point of the room temperature molten salt used in a secondary battery is 25° C. or less. Further, the organic cation generally has a quaternary ammonium skeleton.

The polymer solid electrolyte is prepared by dissolving the electrolyte salt in a polymeric material, and solidifying it.

The inorganic solid electrolyte is a solid substance having lithium ion conductivity.

(4) Separator

The separator may be made of, for example, a porous film or synthetic resin nonwoven fabric including polyethylene, polypropylene, cellulose, or polyvinylidene fluoride (PVdF). In view of safety, a porous film made of polyethylene or polypropylene is preferred. This is because such a porous film melts at a fixed temperature and thus able to shut off current.

(5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal case is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), square, cylinder, coin, or button-shaped. The container member can be properly selected depending on battery size or intended use of the battery.

(6) Negative Electrode Terminal

The negative electrode terminal may be made of a material that is electrochemically stable at the potential at which Li is inserted into and extracted from the above-described negative electrode active material, and has electrical conductivity. Specific examples of the material for the negative electrode terminal include copper, nickel, stainless steel, aluminum, and aluminum alloy containing at least one element selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce the contact resistance with the negative electrode current collector.

(7) Positive Electrode Terminal

The positive electrode terminal may be made of, for example, a material that is electrically stable in the potential range of 3 V to 5 V (vs. Li/Li⁺) relative to the oxidation-and-reduction potential of lithium, and has electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance with the positive electrode current collector.

Next, the secondary battery according to the second embodiment will be more specifically described with reference to the drawings.

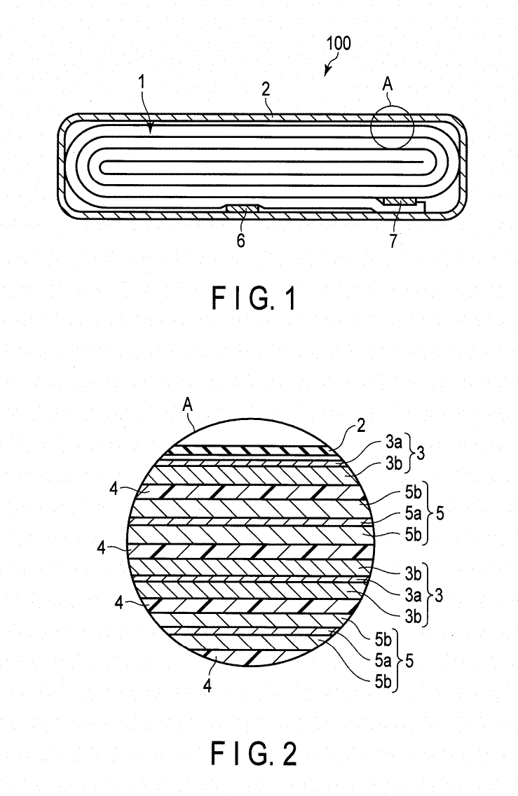

FIG. 1 is a cross-sectional view schematically showing an example of a secondary battery according to the embodiment. FIG. 2 is an enlarged cross-sectional view of section A of the secondary battery shown in FIG. 1.

The secondary battery 100 shown in FIGS. 1 and 2 includes a bag-shaped container member 2 shown in FIG. 1, an electrode group 1 shown in FIGS. 1 and 2, and an electrolyte, which is not shown. The electrode group 1 and the electrolyte are housed in the bag-shaped container member 2. The electrolyte (not shown) is held in the electrode group 1.

The bag shaped container member 2 is made of a laminate film including two resin layers and a metal layer sandwiched between the resin layers.

As shown in FIG. 1, the electrode group 1 is a wound electrode group in a flat form. The wound electrode group 1 in a flat form includes a negative electrode 3, a separator 4, and a positive electrode 5, as shown in FIG. 2. The separator 4 is sandwiched between the negative electrode 3 and the positive electrode 5.

The negative electrode 3 includes a negative electrode current collector 3a and a negative electrode active material-containing layer 3b. The active material is included in the negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 2. For the other portions of the negative electrode 3, negative electrode active material-containing layers 3b are formed on both of reverse surfaces of the negative electrode current collector 3a.

The positive electrode 5 includes a positive electrode current collector 5a and positive electrode active material-containing layers 5b formed on both of reverse surfaces of the positive electrode current collector 5a.

As shown in FIG. 1, a negative electrode terminal 6 and positive electrode terminal 7 are positioned in vicinity of the outer peripheral edge of the wound electrode group 1. The negative electrode terminal 6 is connected to a portion of the negative electrode current collector 3a of the negative electrode 3 positioned outermost. The positive electrode terminal 7 is connected to the positive electrode current collector 5a of the positive electrode 5 positioned outermost. The negative electrode terminal 6 and the positive electrode terminal 7 extend out from an opening of the bag-shaped container member 2. The bag-shaped container member 2 is heat-sealed by a thermoplastic resin layer arranged on the interior thereof.

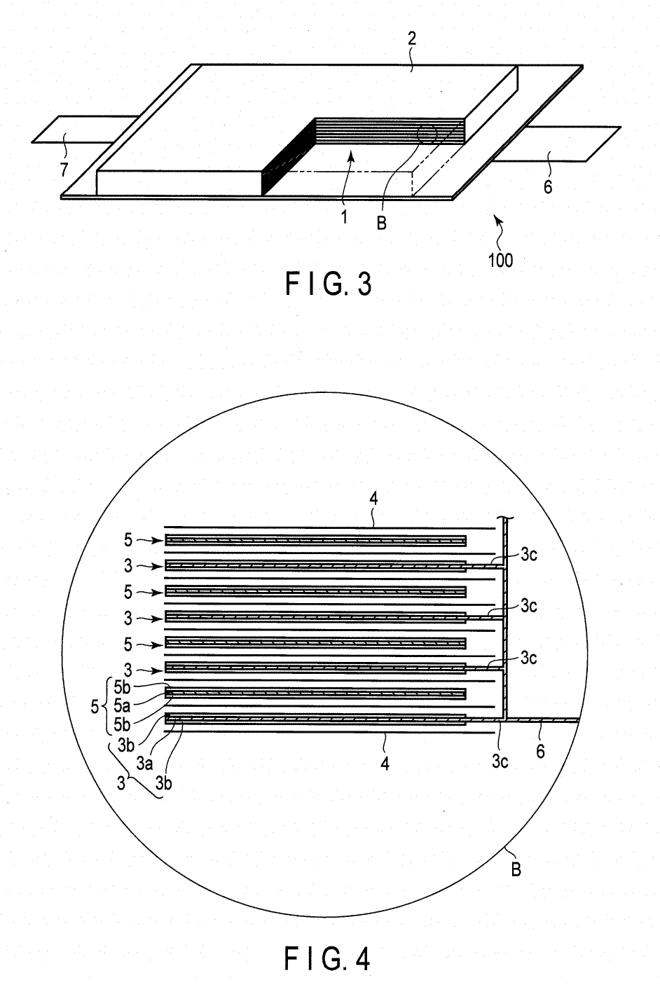

The secondary battery according to the embodiment is not limited to the secondary battery of the structure shown in FIGS. 1 and 2, and may be, for example, a battery of a structure as shown in FIGS. 3 and 4.

FIG. 3 is a partially cut-out perspective view schematically showing another example of a secondary battery according to the embodiment. FIG. 4 is an enlarged cross-sectional view of section B of the secondary battery shown in FIG. 3.

The secondary battery 100 shown in FIGS. 3 and 4 includes an electrode group 1 shown in FIGS. 3 and 4, a container member 2 shown in FIG. 3, and an electrolyte, which is not shown. The electrode group 1 and the electrolyte are housed in the container member 2. The electrolyte is held in the electrode group 1.

The container member 2 is made of a laminate film including two resin layers and a metal layer sandwiched between the resin layers.

As shown in FIG. 4, the electrode group 1 is a stacked electrode group. The stacked electrode group 1 has a structure in which positive electrodes 3 and negative electrodes 5 are alternately stacked with separator(s) 4 sandwiched therebetween.

The electrode group 1 includes a plurality of the negative electrodes 3. Each of the negative electrodes 3 includes the negative electrode current collector 3a and the negative electrode active material-containing layers 3b supported on both surfaces of the negative electrode current collector 3a. The electrode group 1 further includes a plurality of the positive electrodes 5. Each of the positive electrodes 5 includes the positive electrode current collector 5a and the positive electrode active material-containing layers 5b supported on both surfaces of the positive electrode current collector 5a.

The negative electrode current collector 3a of each of the negative electrodes 3 includes at its side a portion 3c where the negative electrode active material-containing layer 3b is not supported on any surface. This portion 3c serves as a negative electrode tab. As shown in FIG. 4, the portion 3c serving as the negative electrode tab does not overlap the positive electrode 5. A plurality of the negative electrode tabs (portions 3c) are electrically connected to the belt-like negative electrode terminal 6. A leading end of the belt-like negative electrode terminal 6 is drawn to the outside from a container member 2.

Although not shown, the positive electrode current collector 5a of each of the positive electrodes 5 includes at its side a portion where the positive electrode active material-containing layer 5b is not supported on any surface. This portion serves as a positive electrode tab. Like the negative electrode tab (portion 3 c), the positive electrode tab does not overlap the negative electrode 3. Further, the positive electrode tab is located on the opposite side of the electrode group 1 with respect to the negative electrode tab (portion 3c). The positive electrode tab is electrically connected to the belt-like positive electrode terminal 7. A leading end of the belt-like positive electrode terminal 7 is located on the opposite side of the negative electrode terminal 6 and drawn to the outside from the container member 2.

The secondary battery according to the embodiment may form a battery module. The battery module includes plural secondary batteries according to the embodiment.

In the battery module according to the embodiment, each of the single batteries may be arranged electrically connected in series, in parallel, or in a combination of in-series connection and in-parallel connection.

An example of the battery module according to the embodiment will be described next with reference to the drawings.

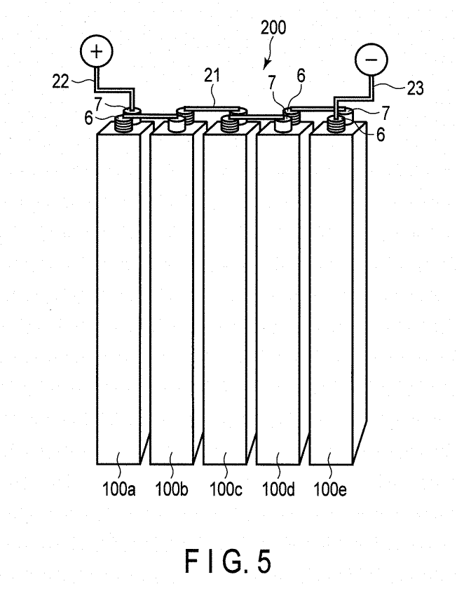

FIG. 5 is a perspective view schematically showing an example of the battery module according to the embodiment. A battery module 200 shown in FIG. 5 includes five single-batteries 100a to 100e, four bus bars 21, a positive electrode-side lead 22, and a negative electrode-side lead 23. Each of the five single-batteries 100a to 100e is a secondary battery according to the embodiment.

For example, a bus bar 21 connects a negative electrode terminal 6 of one single-battery 100a and a positive electrode terminal 7 of the single-battery 100b positioned adjacent. The five single-batteries 100 are thus connected in series by the four bus bars 21. That is, the battery module 200 shown in FIG. 5 is a battery module of five in-series connection.

As shown in FIG. 5, the positive electrode terminal 7 of the single-battery 100a located at one end on the left among the row of the five single-batteries 100a to 100e is connected to the positive electrode-side lead 22 for external connection. In addition, the negative electrode terminal 6 of the single-battery 100e located at the other end on the right among the row of the five single-batteries 100a to 100e is connected to the negative electrode-side lead 23 for external connection.

The secondary battery according to the second embodiment includes a negative electrode, a positive electrode, and an electrolyte. At least one of the negative electrode and the positive electrode is the electrode according to the first embodiment. Hence, the secondary battery has excellent output performance and life performance.

### Third Embodiment

According to a third embodiment, a battery pack is provided. The battery pack includes a secondary battery according to the second embodiment. The battery pack may include one secondary battery according to the second embodiment or may include a battery module formed by a plurality of secondary batteries.

The battery pack according to the embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the embodiment may further comprise an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

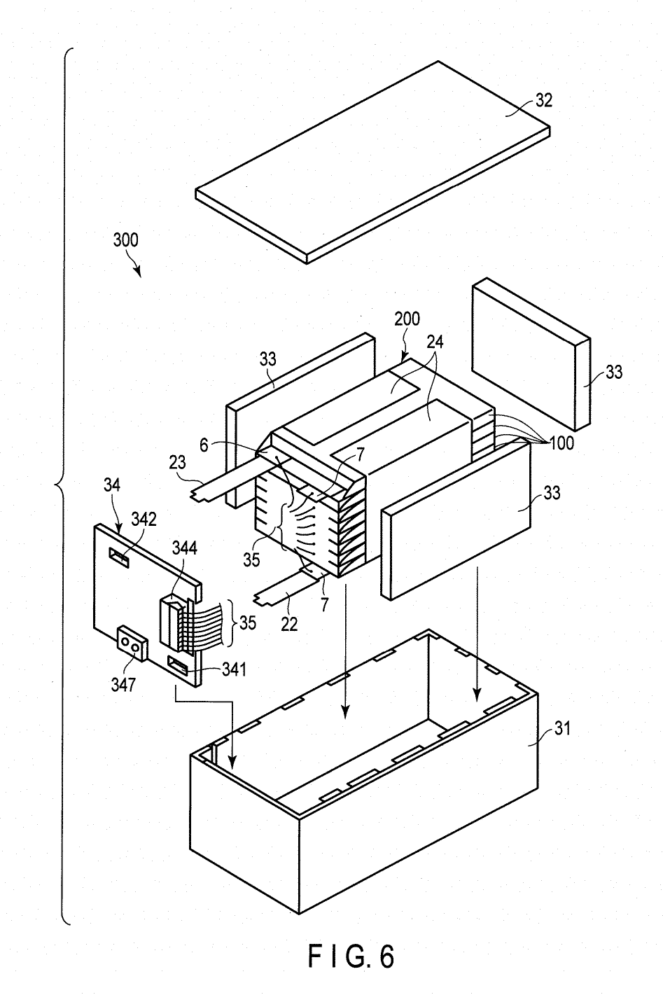

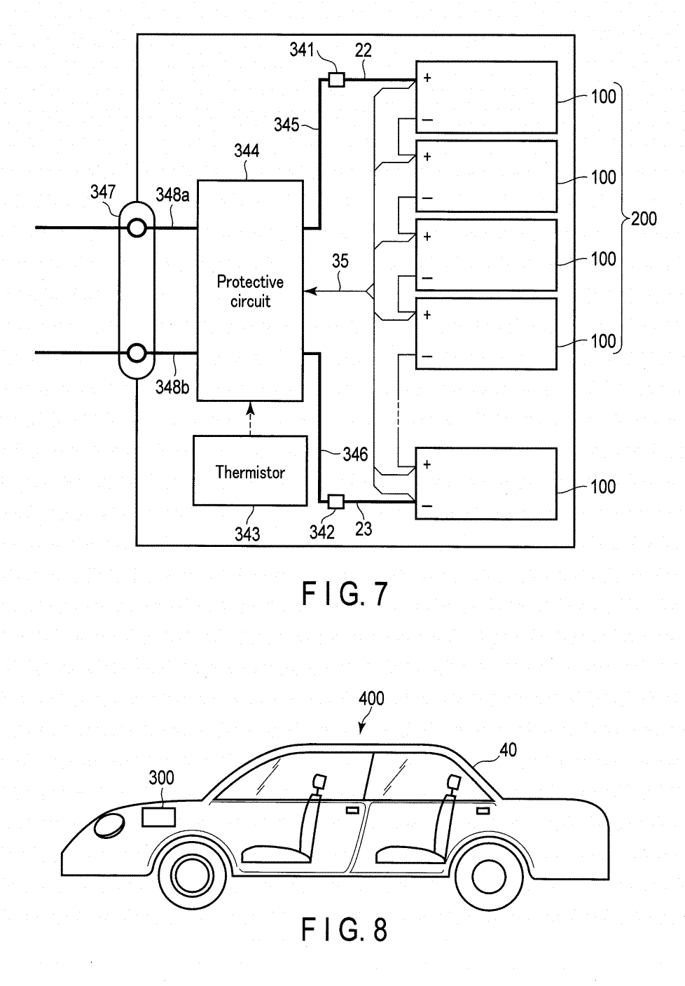

FIG. 6 is an exploded perspective view schematically showing an example of the battery pack according to the embodiment. FIG. 7 is a block diagram showing an example of an electric circuit of the battery pack shown in FIG. 6.

A battery pack 300 shown in FIGS. 6 and 7 includes a housing container 31, a lid 32, protective sheets 33, a battery module 200, a printed wiring board 34, wires 35, and an insulating plate (not shown).

The housing container 31 shown in FIG. 6 is a square bottomed container having a rectangular bottom surface. The housing container 31 is configured to be capable of storing the protective sheets 33, the battery module 200, the printed wiring board 34, and the wires 35. The lid 32 has a rectangular shape. The lid 32 covers the housing container 31 to store the battery module 200 and so on. The housing container 31 and the lid 32 are provided with openings, connection terminals, or the like (not shown) for connection to an external device or the like.

The battery module 200 includes plural single-batteries 100, a positive electrode-side lead 22, a negative electrode-side lead 23, and an adhesive tape 24.

A single-battery 100 has a structure shown in FIGS. 1 and 2. At least one of the plural single-batteries 100 is a secondary battery according to the second embodiment. The plural single-batteries 100 are stacked such that the negative electrode terminals 6 and the positive electrode terminals 7, which extend outside, are directed toward the same direction. The plural single-batteries 100 are electrically connected in series, as shown in FIG. 7. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape 24 fastens the plural single-batteries 100. The plural single-batteries 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural single-batteries 100.

One end of the positive electrode-side lead 22 is connected to the positive electrode terminal 7 of the single-battery 100 located lowermost in the stack of the single-batteries 100. One end of the negative electrode-side lead 23 is connected to the negative electrode terminal 6 of the single-battery 100 located uppermost in the stack of the single-batteries 100.

A printed wiring board 34 is disposed on the one inner surface along the short-side direction of inner surfaces of the housing container 31. The printed wiring board 34 includes a positive electrode-side connector 341, a negative electrode-side connector 342, a thermistor 343, a protective circuit 344, wirings 345 and 346, an external power distribution terminal 347, a plus-side (positive-side) wire 348a, and a minus-side (negative-side) wire 348b. One main surface of the printed wiring board 34 faces the surface of the battery module 200 from which the negative electrode terminals 6 and the positive electrode terminals 7 extend out. An insulating plate (not shown) is disposed in between the printed wiring board 34 and the battery module 200.

The positive electrode-side connector 341 is provided with a through-hole. By inserting the other end of the positive electrode-side lead 22 into the though-hole, the positive electrode-side connector 341 and the positive electrode-side lead 22 become electrically connected. The negative electrode-side connector 342 is provided with a through-hole. By inserting the other end of the negative electrode-side lead 23 into the though-hole, the negative electrode-side connector 342 and the negative electrode-side lead 23 become electrically connected.

The thermistor 343 is fixed to one main surface of the printed wiring board 34. The thermistor 343 detects the temperature of each single-battery 100 and transmits detection signals to the protective circuit 344.

The external power distribution terminal 347 is fixed to the other main surface of the printed wiring board 34. The external power distribution terminal 347 is electrically connected to device(s) that exists outside the battery pack 300.

The protective circuit 344 is fixed to the other main surface of the printed wiring board 34. The protective circuit 344 is connected to the external power distribution terminal 347 via the plus-side wire 348a. The protective circuit 344 is connected to the external power distribution terminal 347 via the minus-side wire 348b. In addition, the protective circuit 344 is electrically connected to the positive electrode-side connector 341 via the wiring 345. The protective circuit 344 is electrically connected to the negative electrode-side connector 342 via the wiring 346. Furthermore, the protective circuit 344 is electrically connected to each of the plural single-batteries 100 via the wires 35.

The protective sheets 33 are arranged on both inner surfaces of the housing container 31 along the long-side direction and on the inner surface along the short-side direction, facing the printed wiring board 34 across the battery module 200 positioned therebetween. The protective sheets 33 are made of, for example, resin or rubber.

The protective circuit 344 controls charge and discharge of the plural single-batteries 100. The protective circuit 344 is also configured to cut-off electric connection between the protective circuit 344 and the external power distribution terminal 347 to external devices, based on detection signals transmitted from the thermistor 343 or detection signals transmitted from each single-battery 100 or the battery module 200.

An example of the detection signal transmitted from the thermistor 343 is a signal indicating that the temperature of the single-battery (single-batteries) 100 is detected to be a predetermined temperature or more. An example of the detection signal transmitted from each single-battery 100 or the battery module 200 is a signal indicating detection of over-charge, over-discharge, and overcurrent of the single-battery (single-batteries) 100. When detecting over-charge or the like for each of the single batteries 100, the battery voltage may be detected, or a positive electrode potential or negative electrode potential may be detected. In the latter case, a lithium electrode to be used as a reference electrode may be inserted into each single battery 100.

Note that, as the protective circuit 344, a circuit included in a device (for example, an electronic device or an automobile) that uses the battery pack 300 as a power source may be used.

As described above, the battery pack 300 includes the external power distribution terminal 347. Hence, the battery pack 300 can output current from the battery module 200 to an external device and input current from an external device to the battery module 200 via the external power distribution terminal 347. In other words, when using the battery pack 300 as a power source, the current from the battery module 200 is supplied to an external device via the external power distribution terminal 347. When charging the battery pack 300, a charge current from an external device is supplied to the battery pack 300 via the external power distribution terminal 347. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may be used as the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for vehicles. An example of the electronic device is a digital camera. The battery pack 300 is particularly favorably used as an onboard battery.

The battery pack according to the third embodiment includes the secondary battery according to the second embodiment. Hence, the battery pack has excellent output performance and life performance.

### Fourth Embodiment

According to a fourth embodiment, a vehicle is provided. The battery pack according to the third embodiment is installed on this vehicle.

In the vehicle according to the embodiment, the battery pack is configured, for example, to recover regenerative energy from motive force of the vehicle. The vehicle can include a mechanism configured to convert kinetic energy of the vehicle into regenerative energy.

Examples of the vehicle according to the embodiment include two- to four-wheeled hybrid electric automobiles, two- to four-wheeled electric automobiles, electric assist bicycles, and railway cars.

In the vehicle according to the embodiment, the installing position of the battery pack is not particularly limited. For example, the battery pack may be installed in the engine compartment of the vehicle, in rear parts of the vehicle, or under seats.

An example of the vehicle according to the embodiment is explained below, with reference to the drawings.

FIG. 8 is a cross-sectional view schematically showing an example of a vehicle according to the embodiment. A vehicle 400, shown in FIG. 8 includes a vehicle body 40 and a battery pack 300 according to the third embodiment. In FIG. 8, the vehicle 400 is a four-wheeled automobile.

This vehicle 400 may have plural battery packs 300 installed. In such a case, the battery packs 300 may be connected in series, connected in parallel, or connected in a combination of in-series connection and in-parallel connection.

An example is shown in FIG. 8, where the battery pack 300 is installed in an engine compartment located at the front of the vehicle body 40. As described above, the battery pack 300 may be installed, for example, in rear sections of the vehicle body 40, or under a seat. The battery pack 300 may be used as a power source of the vehicle 400. The battery pack 300 can also recover regenerative energy of power of the vehicle 400.

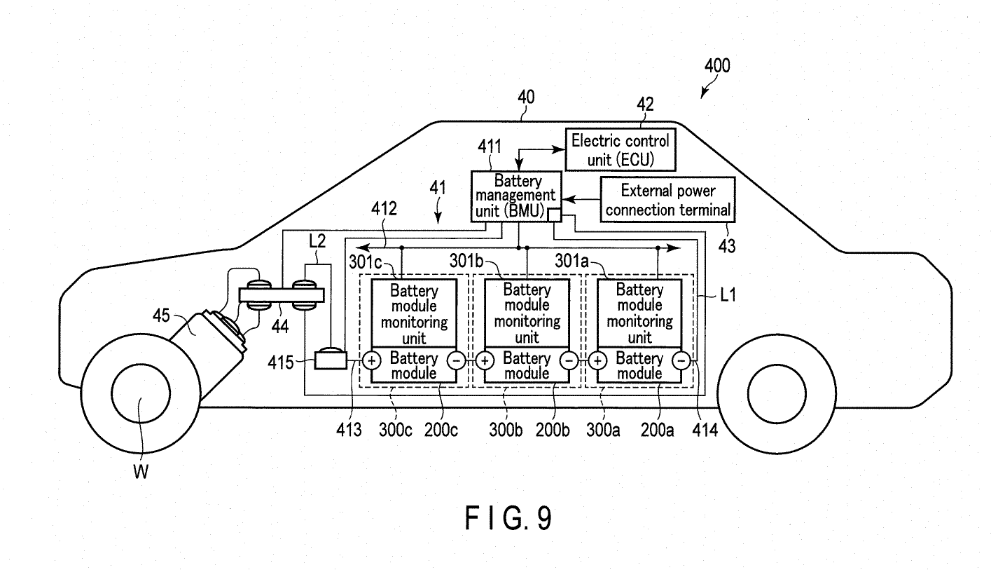

Next, with reference to FIG. 9, an aspect of operation of the vehicle according to the embodiment is explained.

FIG. 9 is a view schematically showing another example of the vehicle according to the embodiment. A vehicle 400, shown in FIG. 9, is an electric automobile.

The vehicle 400, shown in FIG. 9, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 9, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

The three battery packs 300a, 300b and 300c are electrically connected in series. The battery pack 300a includes a battery module 200a and a battery module monitoring unit (for example, VTM: voltage temperature monitoring) 301a. The battery pack 300b includes a battery module 200b, and a battery module monitoring unit 301b. The battery pack 300c includes a battery module 200c, and a battery module monitoring unit 301c. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the embodiment. The battery modules 200a to 200c each perform charging and discharging via a positive electrode terminal 413 and a negative electrode terminal 414.

In order to collect information concerning security of the vehicle power source 41, the battery management unit 411 performs communication with the battery module monitoring units 301a to 301c and collects information such as voltages or temperatures of the single-batteries 100 included in the battery modules 200a to 200c included in the vehicle power source 41.

The communication bus 412 is connected between the battery management unit 411 and the battery module monitoring units 301a to 301c. The communication bus 412 is configured so that multiple nodes (i.e., the battery management unit and one or more battery module monitoring units) share a set of communication lines. The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 9) for switching connection between the positive electrode terminal 413 and the negative electrode terminal 414. The switch unit 415 includes a precharge switch (not shown), which is turned on when the battery modules 200a to 200c are charged, and a main switch (not shown), which is turned on when battery output is supplied to a load. The precharge switch and the main switch include a relay circuit (not shown), which is turned on or off based on a signal provided to a coil disposed near a switch element.

The inverter 44 converts an inputted direct current voltage to a three-phase alternate current (AC) high voltage for driving a motor. Three-phase output terminal(s) of the inverter 44 is (are) connected to each three-phase input, terminal of the drive motor 45. The inverter 44 controls an output voltage based on control signals from the battery management unit 411 or the vehicle ECU 42, which controls the entire operation of the vehicle.

The drive motor 45 is rotated by electric power supplied from the inverter 44. The rotation is transferred to an axle and driving wheels W via a differential gear unit, for example.

The vehicle 400 also includes a regenerative brake mechanism, though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The direct current is inputted into the vehicle power source 41. The DC current is input to, for example, a battery pack provided in the vehicle power supply 41.

One terminal of a connecting line L1 is connected via a current detector (not shown) in the battery management unit 411 to the negative electrode terminal 414 of the vehicle power source 41. The other terminal of the connecting line L1 is connected to a negative electrode input terminal of the inverter 44.

One terminal of a connecting line L2 is connected via the switch unit 415 to the positive electrode terminal 413 of the vehicle power source 41. The other terminal of the connecting line L2 is connected to a positive electrode input terminal of the inverter 44.

The external terminal 43 is connected to the battery management unit 411. The external terminal 43 is able to connect, for example, to an external power source.

The vehicle ECU 42 cooperatively controls the battery management unit 411 together with other units in response to inputs operated by a driver or the like, thereby performing the management of the whole vehicle. Data concerning the security of the vehicle power source 41, such as a remaining capacity of the vehicle power source 41, are transferred between the battery management unit 411 and the vehicle ECU 42 via communication lines.

The vehicle according to the fourth embodiment includes the battery pack according to the third embodiment. Hence, according to this embodiment, it is possible to provide a vehicle in which a battery pack having excellent output performance and life performance is mounted.

### EXAMPLES

Examples of the present invention will be described below. However, the present invention is not limited to the examples to be described below.

### Example 1

<Creation of Active Material Complex AC1>

First, Nb₂O₅ and TiO₂ that were commercially available oxide reagents were prepared. These powders were weighed such that the molar ratio of Nb/Ti became 1.0. These reagents were mixed for 1 hr using a ball mill. The obtained mixture was put in an electric furnace and subjected to temporary firing at a temperature of 1,000° C. for 12 hrs. The powder after the temporary firing was put in the ball mill again, TiO₂ powder was added such that the final Nb/Ti molar ratio became 0.5, and mixing was performed for 3 hrs. The mixture was put in the electric furnace again, and the first final firing was performed at a temperature of 1,100° C. for 5 hrs. After cooling to the room temperature, pulverization using the ball mill was performed for 1 hr, and the second final firing was performed at a temperature of 1,100° C. for 5 hrs. After that, an annealing process was performed at a temperature of 500° C. for 2 hrs. The powder after the annealing process was lightly pulverized using an agate mortar to loosen the agglomeration of the particles. The particles of the monoclinic niobium-titanium composite oxide represented by Nb₂TiO₇ were thus obtained as active material particles. The active material particles will be referred to as active material particles AM1 hereinafter.

For the active material particles AM1, according to the method described in the embodiment, the BET specific surface area and the average particle size (D50) of primary particles were decided, and an average value FUₐᵥₑ of uneven shape coefficients FU was further decided. As a result, the specific surface area was 1.2 m²/g, the average particle size (D50) of the primary particles was 2.1 μm, and the average value FUₐᵥₑ of the uneven shape coefficients FU was 0.71.

For 100 parts by mass of the active material particles AM1, 5 parts by mass of maltose were prepared. The maltose was dispersed in a solvent mixture containing ethanol and pure water at a volume ratio of 1:3, thereby preparing a solution with a viscosity μ of 10 Pa·s. The active material particles were put in this solution, and they were mixed by a ball mill. After mixing, the mixture was dried by a heater at a temperature of 60° C. to completely evaporate water. A complex including the active material particles and a phase including a carbon containing compound that covers at least a part of the surfaces of the active material particles was obtained. Reduction firing was performed for the obtained complex under a nitrogen atmosphere at 700° C. for 3 hrs. By this firing, an active material complex was obtained. The active material complex will be referred to as the active material complex AC1 hereinafter.

When the specific surface area of the active material complex was measured by the BET method, the specific surface area was 1.2 m²/g. In addition, the thickness of the carbon-containing layer was 4.3 nm, the carbon-containing layer covering amount was 1.4 parts by weight, a peak intensity I_{G} was 15.6, a peak intensity I_{D} was 12.0, and a peak intensity ratio I_{G}/I_{D} was 1.3.

<Production of Negative Electrode>

A negative electrode was produced by the following method using the active material complex AC1.

Hundred parts by mass of the active material complex AC1, 4 parts by mass of acetylene black, 3 parts by mass of graphite, 3 parts by mass of polyvinylidene fluoride (PVdF), and N-methylpyrrolidone (NMP) were mixed to prepare a slurry. The slurry was applied to both surfaces of a current collector made of an aluminum foil having a thickness of 12 μm and dried. After drying, pressing was performed, thereby producing a negative electrode whose weight per unit area was 50 g/m².

<Production of Positive Electrode>

Particles of LiNi_{0.5} Co_{0.2}Mn_{0.3}O₂ composite oxide serving as a positive electrode active material in which the average particle size of primary particles was 2 μm, graphite powder serving as a conductive agent, and polyvinylidene fluoride (PVdF) serving as a binder were prepared. The positive electrode active material, the conductive agent, and the binder were compounded at a ratio of 90 wt %, 6 wt %, and 4 wt % with respect to 100 wt % of a positive electrode active material-containing layer and dispersed in an N-methyl-2-pyrrolidone NMP solvent, thereby preparing a slurry. The slurry was applied to both surfaces of an aluminum alloy foil (purity: 99%) having a thickness of 15 μm, and the coat was dried, thereby obtaining a laminated body including the current collector and the active material-containing layer. The laminated body was pressed, thereby producing a positive electrode whose current density was 3.2 g/m³.

<Preparation of Electrolyte>

Propylene carbonate and diethyl carbonate were mixed at a volume ratio of 1:2 to prepare a solvent mixture. LiPF₆ was dissolved in the solvent mixture at a concentration of 1.2 M, thereby preparing a nonaqueous electrolyte.

<Production of Secondary Battery>

A separator formed from a porous film made of polyethylene and having a thickness of 12 μm was arranged between the positive electrode and the negative electrode obtained above. They were spirally wound such that the negative electrode was located on the outermost periphery to produce an electrode group. The electrode group was hot-pressed at 90° C. to produce a flat electrode group. The obtained electrode group was stored in a thin metal can made of stainless steel and having a thickness of 0.25 mm. After the electrolyte was poured in the metal can, sealing was performed, thereby producing a secondary battery.

### Example 2

A negative electrode was produced by the same method as that described in Example 1 except that the amount of acetylene black was changed from 4 parts by mass to 2 parts by mass, the amount of graphite was changed from 3 parts by mass to 4 parts by mass, and the amount of PVdF was changed from 3 parts by mass to 2 parts by mass. A battery was obtained by the same method as that described in Example 1 except that this negative electrode was used.

### Example 3

Active material particles were synthesized by the same method as that described in Example 1 except that the amount of TiO₂ or Nb₂O₅ added after temporary firing was changed to change the final Nb/Ti molar ratio to 0.6. The active material particles will be referred to as active material particles AM2 hereinafter.

For the active material particles AM2, according to the method described in the embodiment, the BET specific surface area and the average particle size (D50) of primary particles were decided, and an average value FUₐᵥₑ of uneven shape coefficients FU was further decided. As a result, the specific surface area was 0.5 m²/g, the average particle size (D50) of the primary particles was 2.0 μm, and the average value FUₐᵥₑ of the uneven shape coefficients FU was 0.72.

Next, a maltose solution was prepared in accordance with the same procedure as in Example 1 except that a solvent mixture of acrylate, ethanol, and pure water (volume ratio was 1:1:3) was used in place of the solvent mixture of ethanol and pure water. The viscosity of the maltose solution was 20 Pa·s. The active material particles AM2 were put in this solution, and an active material complex was obtained in accordance with the same procedure as in Example 1. The active material complex will be referred to as an active material complex AC2 hereinafter.

When the specific surface area of the active material complex was measured by the BET method, the specific surface area was 0.5 m²/g. In addition, the thickness of the carbon-containing layer was 3.1 nm, the carbon-containing layer covering amount was 1.6 parts by weight, a peak intensity I_{G} was 20.7, a peak intensity I_{D} was 11.5, and a peak intensity ratio I_{G}/I_{D} was 1.8.

A negative electrode was produced by the same method as that described in Example 1 except that the active material complex AC2 was used in place of the active material complex AC1, the amount of acetylene black was changed from 4 parts by mass to 6 parts by mass, the amount of graphite was changed from 3 parts by mass to 4 parts by mass, and the amount of PVdF was changed from 3 parts by mass to 5 parts by mass. A battery was obtained by the same method as that described in Example 1 except that this negative electrode was used.

### Example 4

Active material particles were synthesized by the same method as that described in Example 1 except that the amount of TiO₂ or Nb₂O₅ added after temporary firing was changed to change the final Nb/Ti molar ratio to 0.4. The active material particles will be referred to as active material particles AM3 hereinafter.

For the active material particles AM3, according to the method described in the embodiment, the BET specific surface area and the average particle size (D50) of primary particles were decided, and an average value FUₐᵥₑ of uneven shape coefficients FU was further decided. As a result, the specific surface area was 4.1 m²/g, the average particle size (D50) of the primary particles was 1.9 μm, and the average value FUₐᵥₑ of the uneven shape coefficients FU was 0.72.

For 100 parts by weight of the active material particles, 10 parts by weight of polyvinyl alcohol (PVA) were prepared. The PVA was dispersed in a solvent mixture containing ethanol and pure water at a volume ratio of 1:3, thereby preparing a solution with a viscosity μ of 25 Pa·s. The active material particles AM3 were put in this solution, and they were mixed by a ball mill. After mixing, the mixture was dried by a heater at a temperature of 60° C. to completely evaporate water. A complex including the active material particles and a phase including a carbon containing compound that covers at least a part of the surfaces of the active material particles was obtained. Reduction firing was performed for the obtained complex under a nitrogen atmosphere at 800° C. for 20 hrs. By this firing, an active material complex was obtained. The active material complex will be referred to as the active material complex AC3 hereinafter.

When the specific surface area of the active material complex was measured by the BET method, the specific surface area was 4.1 m²/g. In addition, the thickness of the carbon-containing layer was 6.2 nm, the carbon-containing layer covering amount was 1.4 parts by weight, a peak intensity I_{G} was 24.5, a peak intensity I_{D} was 5.1, and a peak intensity ratio I_{G}/I_{D} was 4.8.

A negative electrode was produced by the same method as that described in Example 1 except that the active material complex AC3 was used in place of the active material complex AC1, the amount of acetylene black was changed from 4 parts by mass to 1 parts by mass, and the amount of PVdF was changed from 3 parts by mass to 5 parts by mass. A battery was obtained by the same method as that described in Example 1 except that this negative electrode was used.

### Comparative Example 1

Active material particles were synthesized by the same method as that described in Example 1 except that the amount of TiO₂ or Nb₂O₅ added after temporary firing was changed to change the final Nb/Ti molar ratio to 0.5. The active material particles will be referred to as active material particles AM4 hereinafter.

For the active material particles AM4, according to the method described in the embodiment, the BET specific surface area and the average particle size (D50) of primary particles were decided, and an average value FUₐᵥₑ of uneven shape coefficients FU was further decided. As a result, the specific surface area was 8.8 m²/g, the average particle size (D50) of the primary particles was 1.8 μm, and the average value FUₐᵥₑ of the uneven shape coefficients FU was 0.71.

Next, a maltose solution was prepared in accordance with the same procedure as in Example 1 except that pure water was used in place of the solvent mixture of ethanol and pure water. The viscosity of the maltose solution was 5 Pa·s. The active material particles AM4 were put in this solution, and they were mixed by a ball mill. After mixing, the mixture was dried by a heater at a temperature of 60° C. to completely evaporate water. A complex including the active material particles and a phase including a carbon containing compound that covers at least a part of the surfaces of the active material particles was obtained. Reduction firing was performed for the obtained complex under a nitrogen atmosphere at 800° C. for 3 hrs. By this firing, an active material complex was obtained. The active material complex will be referred to as the active material complex AC4 hereinafter.

When the specific surface area of the active material complex was measured by the BET method, the specific surface area was 10.8 m²/g. In addition, the thickness of the carbon-containing layer was 3.8 nm, the carbon-containing layer covering amount was 1.5 parts by weight, a peak intensity I_{G} was 13.5, a peak intensity I_{D} was 13.5, and a peak intensity ratio I_{G}/I_{D} was 1.0.

A negative electrode was produced by the same method as that described in Example 1 except that the active material complex AC4 was used in place of the active material complex AC1. A battery was obtained by the same method as that described in Example 1 except that this negative electrode was used.

### Comparative Example 2

A negative electrode was produced by the same method as that described in Example 1 except that the amount of acetylene black was changed from 4 parts by mass to 1 parts by mass, the amount of graphite was changed from 3 parts by mass to 1 parts by mass, and the amount of PVdF was changed from 3 parts by mass to 1 parts by mass. A battery was obtained by the same method as that described in Example 1 except that this negative electrode was used.

### Comparative Example 3

A negative electrode was produced by the same method as that described in Example 3 except that the amount of acetylene black was changed from 6 parts by mass to 10 parts by mass, and the amount of graphite was changed from 4 parts by mass to 10 parts by mass. A battery was obtained by the same method as that described in Example 1 except that this negative electrode was used.

<Evaluation Method>

(Raman Spectroscopic Analysis)

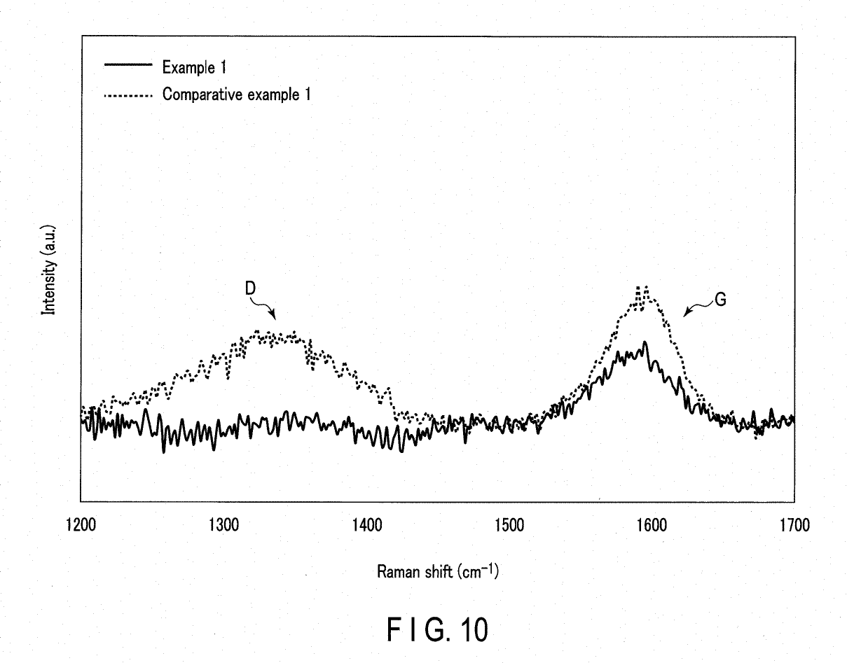

FIG. 10 shows the Raman spectra of active material complexes. FIG. 10 shows the Raman spectrum of the active material complex AC1 used in Example 1 and that of the active material complex AC4 used in Comparative Example 1. In each Raman spectrum shown in FIG. 10, a D band having a peak top almost at 1,350 cm⁻¹ and a G band having a peak top almost at 1,580 cm⁻¹ appeared. The intensities of the peak tops of the D band and the G band of the active material complex AC1 are smaller than the intensities of the peak tops of the D band and the G band of the active material complex AC4.

(Measurement of Specific Surface Area S)

For each of the active material complexes AC1 to AC4, the specific surface area S was measured by the above-described method. Table 1 shows the result.

(Measurement of Sheet Resistance Value ρs)

For each of the negative electrodes according to the examples and the comparative examples, the sheet resistance value ρs was measured by the above-described method. Table 1 shows the result.

(Calculation of Resistance Value ρs·S)

The resistance value ρs·S was calculated from the specific surface area S of the active material complex and the sheet resistance value ρs of the electrode, which were obtained by the above-described method. Table 1 shows the result.

(Measurement of Capacity Retention Ratio of 20 C/1 C)

Each of the batteries produced in the examples and the comparative examples was subjected to rate tests under a 25° C. environment. In charge-and-discharge, first, the battery was charged up to 3.0 V at 1 C and then discharged up to 1.7 V at 1 C, and the capacity of the battery was confirmed. After that, the battery was discharged at 20 C, and the capacity of the battery was confirmed. The capacity retention ratio of 20 C/1 C was calculated from the discharge capacity at the time of 1 C discharge and the 20 C discharge capacity when the discharge capacity at the time of 1 C discharge is defined as 100%. Table 1 shows the result.

[Measurement of Capacity Retention Ratio after 1,000 Cycles]

To evaluate life performance, each of the batteries produced in the examples and the comparative examples was charged up to 3.0 V at 1 A under a 45° C. environment. After that, an interruption time of 30 min was provided. Then, the battery was discharged up to 1.7 V at 1 A, and the interruption time of 30 min was provided again. The series of operations is defined as one charge-and-discharge cycle. This charge-and-discharge cycle was repeated 1,000 times for the created secondary battery. The capacity at the 1,000th cycle with respect to the initial capacity was calculated. Table 1 shows the result.

Data according to the examples and the comparative examples are summarized in Table 1.

TABLE 1

| | Active | | First | Second | | Electrode | | Battery | |
|---|---|---|---|---|---|---|---|---|---|
| | material | | conductive | conductive | | characteristics | | characteristics | |
| | complex | | agent | agent | Binder | Sheet | | 20 C/1 C | Capacity |
| | | Specific | Additive | Additive | Additive | resistance | | capacity | retention |
| | | surface | amount | amount | amount | value | | retention | ratio after |
| | | area S | (parts by | (parts by | (parts by | ρ s | ρ s · S | ratio | 1,000 cycles |
| | Type | (m²/g) | mass) | mass) | mass) | (Ω/m²) | (Ω/g) | (%) | (%) |
| Example 1 | AC1 | 1.2 | 4 | 3 | 3 | 10.5 | 12.6 | 57 | 91.3 |
| Example 2 | AC1 | 1.2 | 2 | 4 | 2 | 18.8 | 22.6 | 59 | 92.5 |
| Example 3 | AC2 | 0.5 | 6 | 4 | 5 | 3.2 | 1.6 | 61 | 93.1 |
| Example 4 | AC3 | 4.1 | 1 | 3 | 5 | 12 | 49.2 | 56 | 87.8 |
| Comparative | AC4 | 10.8 | 4 | 3 | 3 | 30 | 324 | 43 | 75.4 |
| Example 1 | | | | | | | | | |
| Comparative | AC1 | 1.2 | 1 | 1 | 1 | 120 | 144 | 44 | 65.6 |
| Example 2 | | | | | | | | | |
| Comparative | AC2 | 0.5 | 10 | 10 | 5 | 1.6 | 0.8 | 59 | 80.7 |
| Example 3 | | | | | | | | | |

In Table 1, a column with a notation “type” in columns under the heading “active material complex” describes the type of each active material complex. A column with a notation “specific surface area S (m²/g)” describes the nitrogen BET specific surface area of the active material complex.

In addition, columns with notations “additive amount (parts by mass)” in columns under the headings “first conductive agent”, “second conductive agent”, and “binder” respectively describe the amounts of carbon black, graphite, and polyvinylidene fluoride with respect to 100 parts by mass of the active material complex.

In addition, a column with a notation “sheet resistance value ρs (Ω/m²)” in columns under the heading “electrode characteristics” describes the sheet resistance value of an electrode obtained by the above-described method. A column with a notation “ρs·S(Ω/g)” describes the sheet resistance value ρs·S.

In addition, a column with a notation “20 C/1 C capacity retention ratio (%)” in columns under the heading “battery characteristics” describes the 20 C/1 C capacity retention ratio. A column with a notation “capacity retention ratio after 1,000 cycles (%)” describes the capacity retention ratio after 1,000 cycles.

As shown in Table 1, both the 20 C/1 C capacity retention ratio and the capacity retention ratio after 1,000 cycles were excellent in each of the secondary batteries according to Examples 1 to 4 in which the resistance value ρs·S calculated from the specific surface area S(m²/g) of the active material complex by the nitrogen BET method and the sheet resistance value ρs (Ω/m²) of the electrode ranged from 1 Ω/g to 50 Ω/g.

On the other hand, both the 20 C/1 C capacity retention ratio and the capacity retention ratio after 1,000 cycles were low in each of the secondary batteries according to Comparative Examples 1 and 2 in which the resistance value ρs·S is 50 Ω/g or more. In addition, in the secondary battery according to Comparative Example 3 in which the resistance value ρs·S is 1 Ω/g or less, the 20 C/1 C capacity retention ratio was high, but the capacity retention ratio after 1,000 cycles was low.

According to at least one embodiment described above, an electrode is provided. The electrode includes a current collector and an active material-containing layer. The active material-containing layer is provided on at least one surface of the current collector. The active material-containing layer includes an active material complex and a conductive agent. The active material complex includes particles of a niobium-titanium composite oxide and a carbon-containing layer. The carbon-containing layer covers at least one part of surfaces of the particles of the niobium-titanium composite oxide. A resistance value ρs·S satisfies the following formula (1). The resistance value ρs·S is calculated from a specific surface area S (m²/g) of the active material complex by a nitrogen BET method and a sheet resistance value ρs (Ω/m²) of the electrode.

1Ω/g≤ρs·S≤50Ω/g (1)

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising a current collector and an active material-containing layer provided on at least one surface of the current collector, the active material-containing layer comprising an active material complex and a conductive agent,
wherein the active material complex comprises particles of a niobium-titanium composite oxide and a carbon-containing layer which covers at least one part of surfaces of the particles of the niobium-titanium composite oxide, and
a resistance value ρs·S satisfies the following formula (1),
1Ω/g≤ρs·S≤50Ω/g (1)
in the formula (1), ρs is a sheet resistance value (Ω/m²) of the electrode and S is a specific surface area (m²/g) of the active material complex by a nitrogen BET method.

2. The electrode according to claim 1, wherein the specific surface area of the active material complex by the nitrogen BET method ranges from 0.1 m²/g to 5 m²/g.

3. The electrode according to claim 1, wherein the sheet resistance value of the electrode ranges from 1 Ω/m² to 25 Ω/m².

4. The electrode according to claim 1, wherein the conductive agent includes carbon black and graphite.

5. The electrode according to claim 1, wherein the carbon-containing layer satisfies the following formula (2),
1.2<I_{G}/I_{D}≤5 (2)
wherein I_{D} is a peak intensity of a D band that appears in a range of 1,280 to 1,400 cm⁻¹ on a Raman spectrum, and I_{G} is a peak intensity of a G band that appears in a range of 1,530 to 1,650 cm⁻¹ on the Raman spectrum, the Raman spectrum is obtained by Raman spectroscopy using a light source of 532 nm.

6. The electrode according to claim 1, wherein the niobium-titanium composite oxide is represented by LiₐTi₁₋ₓM1ₓNb_{2-y}M2_{y}O₇ (where 0≤a≤5, 0≤x<1, 0≤y<1, M1 is at least one element selected from the group consisting of Nb, V, Ta, Fe, Bi, Sb, As, P, Cr, Mo, W, B, Na, Mg, Al, and Si, M2 is at least one element selected from the group consisting of V, Ta, Fe, Ti, Bi, Sb, As, P, Cr, Mo, W, B, Na, Mg, Al, and Si, and M1 and M2 may be the same or may be different from each other).

7. The electrode according to claim 1, wherein the niobium-titanium composite oxide is represented by LiₐTi₁₋ₓ MₓNb₂)₇ (where 0≤a≤5, 0≤x<1, M is at least one element selected from the group consisting of Nb, V, Ta, Bi, Sb, As, P, Cr, Mo, W, B, Na, Mg, Al, and Si).

8. The electrode according to claim 1, wherein the particles of the niobium-titanium composite oxide include a plurality of primary particles of the niobium-titanium composite oxide, and
an average value (FUₐᵥₑ) of a roughness shape coefficient FU according to Formula (3) below is 0.70 or more in 100 primary particles among the plurality of primary particles, and
each of the 100 primary particles has a particle size of 0.2 times to 4 times an average particle size (D50) determined from a particle size distribution chart of the plurality of primary particles obtained by a laser diffraction scattering method,
$$\begin{matrix}[ Formula 3 ] & \\ FU = \frac{f}{{f}_{c}} = \frac{4 π a}{{𝓁}^{ 2}} & ( 3 )\end{matrix}$$
where l represents an outer circumference length of a projected cross-section of each of the 100 primary particles, and a represents a cross-sectional area in the projected cross-section of each of the 100 primary particles.

9. A secondary battery comprising a positive electrode, a negative electrode, and an electrolyte, wherein at least one of the positive electrode and the negative electrode comprises an electrode according to claim 1.

10. A battery pack comprising the secondary battery according to claim 9.

11. The battery pack according to claim 10, further comprising:
an external power distribution terminal; and
a protective circuit.

12. The battery pack according to claim 10, which includes plural of the secondary battery and the plural of the secondary battery are electrically connected in series, in parallel, or in combination of series and parallel.

13. A vehicle comprising the battery pack according to claim 10.

14. The vehicle according to claim 13, which comprises a mechanism configured to convert kinetic energy of the vehicle into regenerative energy.
